(19) United States
(12) Patent Application Publication
(10) Pub. No.: US 2012/0254017 A1
(43) Pub. Date: Oct. 4, 2012

(54) System and Method for Credit Information Acquisition, Aggregation, and Maintenance

(76) Inventors: Douglas D. Fusco, McKinney, TX (US); Travis A. Diamond, Fairview, TX (US)

(21) Appl. No.: 13/075,461

(22) Filed: Mar. 30, 2011

(51) Int. Cl. G06Q 40/02

(52) U.S. Cl. 705/38

(57) ABSTRACT

A computer implemented system and method, in a client-server environment, is provided for customer credit information acquisition, aggregation, and maintenance, during an automobile sales cycle. An identification (ID) module is configured to capture and associate customer identification data with an electronic customer file, while a credit application module captures and associates a customer credit application with the electronic customer file. An electronic dashboard tracks and selectively displays status of the electronic customer file, while an enforcement module selectively permits and prevents acquisition of a credit report for the customer in accordance with the status of the electronic customer file. A credit report module is configured to, upon permission by the enforcement module, acquire a credit report for the customer and associate it with the customer file.

### BACKGROUND

1. Technical Field

This invention relates to web-enabled transactions, and more particularly to an automated system for credit information acquisition, aggregation, and compliance assurance.

2. Background Information

Identity theft represents a systemic and growing problem within the retail automotive industry. The unique characteristics personnel challenges within this industry exacerbate the problem. While Federal and State legislation dictate specific business processes in an attempt to thwart this growing issue, several problems still exist. Laws and regulations such as those known as the Graham Leach Bliley Act (GLBA), Information Safeguards Act, Red Flags rule, and OFAC (Office of Foreign Assets Control of the U.S. Department of the Treasury) are all focused on how these agencies must not only protect the non public information of their potential customers, but also to make appropriate effort in determining the identity of these same individuals. While some of these laws have been in effect for years, the automotive industry as a whole continues to perform in a substantially non-compliant manner.

Much of this is a result of a combination of the following factors:

The business environment is a very fast paced, high transaction environment, in which a “ready—fire—aim” approach persists. In many cases, the “close the deal first and we will clean it up after the fact” practice is accepted.

The average background of an automotive sales person does not typically include administrative strength as part of their core skill capabilities. They tend to be focused primarily on the next transaction.

Turnover tends to be high, which leads to a need for frequent training.

While dealers tend to train their staffs on these requirements, and make efforts to comply with their policies and procedures, compliance with these procedures tends to fade relatively quickly, e.g., due to turnover, or busy periods where shortcuts are taken to accommodate the pace of sales.

In many cases, during this haste, sales individuals violate basic policies such as not protecting customer non public information, processing credit history requests without the appropriate paperwork and signature, and not securely storing all private documents for both completed transactions and dead deals, to name just a few.

In 2004 there were roughly 750,000 victims of identity theft, and the U.S. Congress passed the GLBA in an attempt to solve this problem. Various Information Safeguards regulations were promulgated as part of that act. The belief was the enforcement of this new law would eliminate or reduce the problem. Unfortunately, it did not. As shown in FIG. 1A, as of 2009 there were roughly 13 Millions victims, a 2,000% increase. This represents one identity stolen every 22 seconds. Research has shown that approximately 62% of all ID theft still involves paper.

In spite of the dealerships' efforts, compliance has been low because there have been no tools at the dealers' disposal to measure, manage, enforce or gain visibility into this process. As a result of that, they really have no way on a consistent basis to measure what is actually going on in the showroom with regard to these regulations and all the paperwork vs. what their required or intending to do based on the training they have had.

Current Process

When a prospective customer walks in to a dealership and says “I would like to buy a car”, the sales representative typically starts to collect various items of non-public information. For example, the sales representative will collect drivers license information, and in some states, the customer's automobile insurance information. The sales representative will then either photocopy it, swipe it into a customer relationship management (CRM) system, or put it in their desk while they go get keys and complete a test drive. The customer is typically told that this information is required for verification of a valid drivers license and insurance, but more often, this information is captured simply for future prospecting.

If the customer wishes to purchase the vehicle, the sales representative will typically have the customer sign and fill out a credit application and privacy statement, which details what the dealership can and cannot do with the information, and how they will protect it. This information is then often taken to a manager to process the customer's credit report.

The law at that point says the manager must have a signed Credit application and a privacy statement, in order to run a credit report. The sales manager will run the credit report, evaluate the credit worthiness of the customer. If it is good, they keep going and if it is bad they will request additional documents, such as a payroll check, proof of employment, proof of residency, water bill, etc., or in some cases even references. Additional non-public information, such as loan balances, used car appraisals, payoff verification, VIN verification, customer worksheet, and/or loaner agreements, may also be collected. Beyond that, similar information may be collected for co-applicants or co-signers.

As the transaction wraps up, whether or not a vehicle is purchased, the dealership must store, archive, and protect the customer's information for a predetermined period of time. This period is currently seven years in the United States, for prospects who purchased a vehicle, and 25 months for those who did not. The applicable laws may impose still further requirements, such as a signed credit application before running credit, obtaining a customer's signature on a privacy statement, enforcing Red Flags verification on credit reports, securing a “clean OFAC” and providing a “Risk Based Pricing Letter”, etc.

A violation of these safeguards, such as by leaving documents unattended on a desktop within a dealership, e.g., where they may be susceptible of being photographed with cell-phone cameras, etc., may result in a fine of $16,000 per document. In addition, these violations may result in identity theft, bad publicity for the dealership, and/or potential legal action based on charges of Unfair or Deceptive Trade Practices.

These are real problems that can shut the doors on just about any dealership today.

Thus, there is a need for a solution to the various unresolved issues associated with conventional information capture and storage in a motor vehicle dealership sales environment.

### SUMMARY

One aspect of the present invention is a computer implemented system in a client-server environment, for customer credit information acquisition, aggregation, and maintenance, during an automobile sales cycle. This system includes a server having an identification (ID) module configured to capture and associate customer identification data with an electronic customer file. A credit application module is configured to capture and associate a customer credit application with the electronic customer file. A dashboard module is configured to generate an electronic dashboard configured to track and selectively display status of the electronic customer file. An enforcement module is configured to selectively permit and prevent acquisition of a credit report for the customer in accordance with the status of the electronic customer file. A credit report module is configured to, upon permission by the enforcement module, acquire and associate a credit report for the customer with the electronic customer file.

In another aspect of the present invention, the previous aspect also includes a time-stamp module configured to apply time-stamps to the items associated with the electronic customer file, and a data integrity module configured to maintain the items associated with the electronic customer file for a predetermined time period subsequent to the time-stamps. A privacy module is configured to capture and associate a privacy statement executed by the customer with the electronic customer file. An insurance module is configured to capture and associate automobile insurance information for the customer with the electronic customer file, and an income module is configured to capture and associate proof of income information for the customer with the electronic customer file. A residency module is configured to capture and associate proof of residency information for the customer with the electronic customer file.

Still another aspect of the invention includes a computer implemented method in a client-server environment, for customer credit information acquisition, aggregation, and maintenance, during a motor vehicle sales cycle. This method includes, at the server, capturing and associating customer identification data, and a customer credit application, with an electronic customer file. The server also generates and configures an electronic dashboard to track and selectively display status of the electronic customer file. The server selectively permits and prevents acquisition of a credit report for the customer in accordance with the status of the electronic customer file, and upon permission by the enforcement module, acquires and associates a credit report for the customer with the electronic customer file.

In yet another aspect of the invention, the foregoing aspect also includes applying time-stamps to the items associated with the electronic customer file, and maintaining the items for a predetermined time period subsequent to the time-stamps. This method also includes capturing and associating with the customer file, a privacy statement, insurance information, proof of income, and proof of residency.

The features and advantages described herein are not all-inclusive and, in particular, many additional features and advantages will be apparent to one of ordinary skill in the art in view of the drawings, specification, and claims. Moreover, it should be noted that the language used in the specification has been principally selected for readability and instructional purposes, and not to limit the scope of the inventive subject matter.

### BRIEF DESCRIPTION OF THE DRAWINGS

The present invention is illustrated by way of example and not limitation in the figures of the accompanying drawings, in which like references indicate similar elements and in which:

FIG. 1A is a graph which plots the number of identity thefts in the United States over time;

FIG. 1B is a block diagram of one embodiment of a network-based transaction facility;

FIG. 2 is a block diagram of one embodiment of a database maintained by a database engine server;

FIG. 3 is a diagrammatic representation of one embodiment of a user table within the database;

FIGS. 4A-4C are diagrammatic representations embodiments of additional tables within the database;

FIG. 5 is a block diagram of one embodiment of a system for verifying the identity of a participant in a transaction facility;

FIG. 6A is a block diagram of one embodiment of an interface sequence/modules implemented by the present invention;

FIG. 6B is a view similar to that of FIG. 6A, for alternate embodiments of the present invention;

FIG. 7A is a flow chart of one embodiment of a method implemented by the network-based transaction facility;

FIG. 7B is a view similar to that of FIG. 7A, for alternate embodiments;

FIGS. 8-25 are exemplary representations of various interfaces included in the sequence of interfaces shown in FIGS. 6A and 6B; and

FIG. 26 is a block diagram of one embodiment of a computer system usable in embodiments of the present invention.

### DETAILED DESCRIPTION

In the following detailed description, reference is made to the accompanying drawings that form a part hereof, and in which is shown by way of illustration, specific embodiments in which the invention may be practiced. These embodiments are described in sufficient detail to enable those skilled in the art to practice the invention, and it is to be understood that other embodiments may be utilized. It is also to be understood that structural, procedural and system changes may be made without departing from the spirit and scope of the present invention. In addition, well-known structures, circuits and techniques have not been shown in detail in order not to obscure the understanding of this description. The following detailed description is, therefore, not to be taken in a limiting sense, and the scope of the present invention is defined by the appended claims and their equivalents.

### General Overview

Embodiments of the present invention provide a Compliance Assurance method and apparatus for the automobile dealer industry. This solution provides the dealer with the tools to ensure that customer information is handled properly, on a real-time basis. These embodiments provide this functionality by delivering a consistent process and a behavior enforcement mechanism with respect to various steps pre- and post-running of a prospective customer's credit. These embodiments provide visibility into behavior patterns that have not been available before, standardization of a compliant process, along with key reporting, to help put dealerships in a defensible position with evidence to support their compliance with applicable laws.

### Terminology

For the purposes of the present specification, the term “transaction” shall be taken to include any communications between two or more entities and shall be construed to include, but not be limited to, various individual steps associated with commercial automobile sales transactions including capture of prospective customer information, credit checking and the like.

As used herein, the terms “computer” and “end-user device” are meant to encompass a workstation, personal computer, personal digital assistant (PDA), wireless telephone, or any other suitable computing device including a processor, a computer readable medium upon which computer readable program code (including instructions and/or data) may be disposed, and a user interface. Terms such as “server”, “application”, “engine” and the like are intended to refer to a computer-related component, including hardware, software, and/or software in execution. For example, an engine may be, but is not limited to being, a process running on a processor, a processor including an object, an executable, a thread of execution, a program, and a computer. Moreover, the various components may be localized on one computer and/or distributed between two or more computers. The terms “real-time” and “on-demand” refer to sensing and responding to external events nearly simultaneously (e.g., within milliseconds or microseconds) with their occurrence, or without intentional delay, given the processing limitations of the system and the time required to accurately respond to the inputs.

Terms such as “component,” “module”, and the like are intended to refer to a computer-related entity, either hardware, a combination of hardware and software, software, or software in execution. For example, a module may be, but is not limited to being, a process running on a processor, a processor, an object, an executable, a thread of execution, a program, and a computer. By way of illustration, both an application running on a server and the server may be modules. One or more modules may reside within a process and/or thread of execution and a module may be localized on one computer and/or distributed between two or more computers or control devices.

### Programming Languages

The systems and methods embodying the present invention can be programmed in any suitable language and technology, such as, but not limited to: C++; Visual Basic; Java; VBScript; Jscript; BCMAscript; DHTM1; XML and CGI. Alternative versions may be developed using other programming languages including, Hypertext Markup Language (HTML), Active ServerPages (ASP) and Javascript. Any suitable database technology can be employed, such as, but not limited to, Microsoft SQL Server or IBM AS 400.

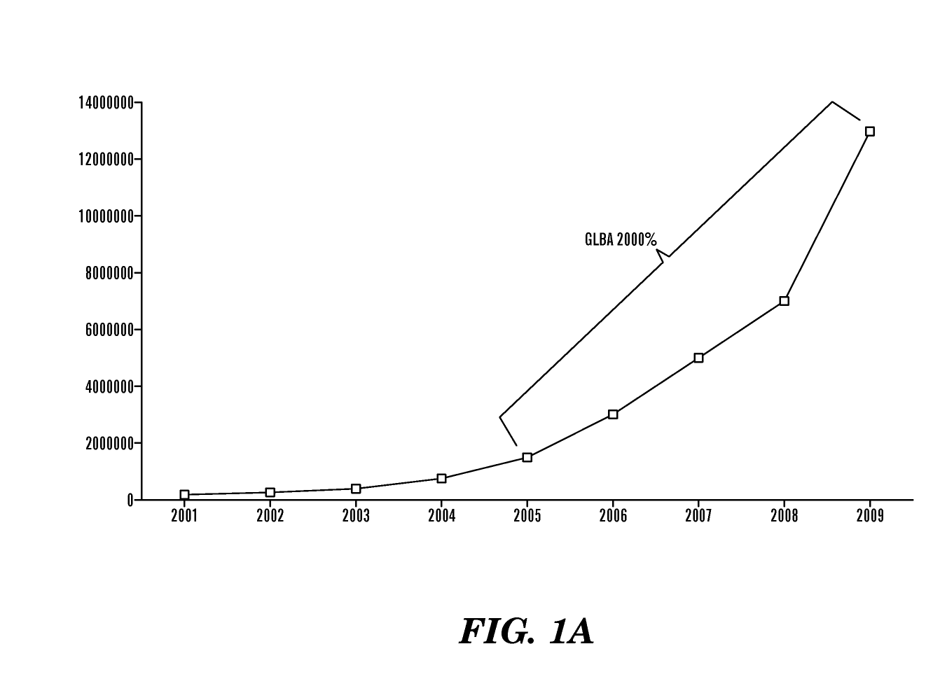

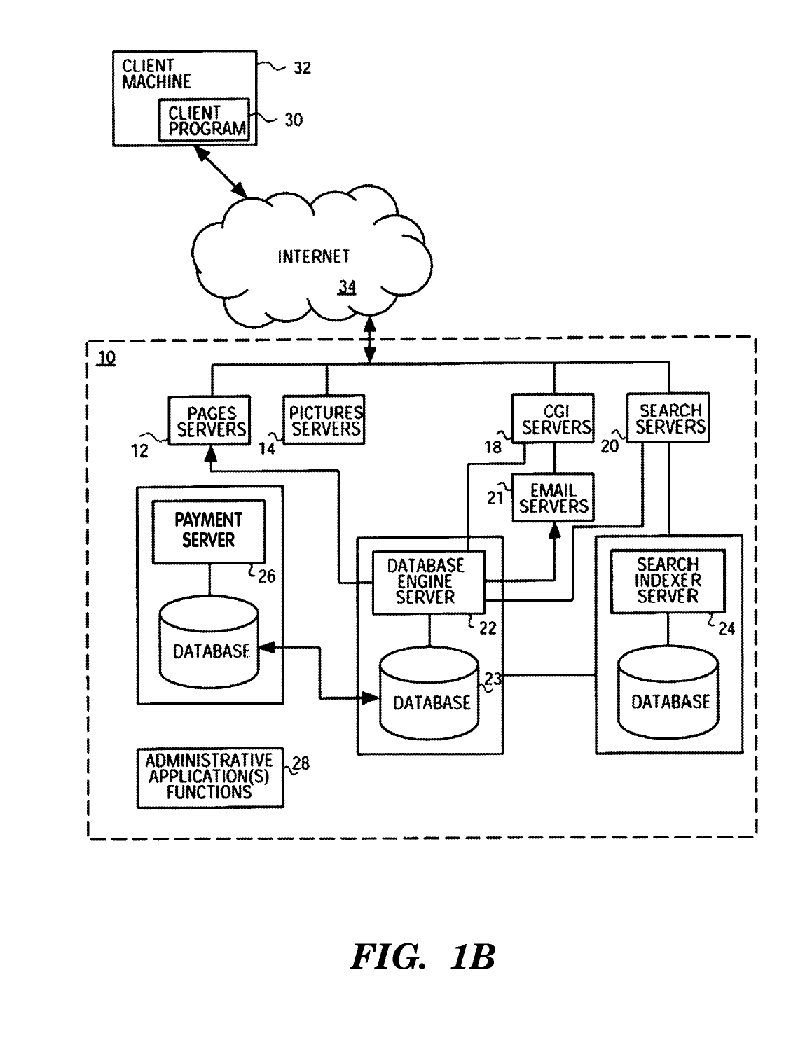

Referring now to FIGS. 1B-26, embodiments of the present invention will be more thoroughly described.

Transaction Facility

FIG. 1A is a block diagram illustrating an exemplary network-based transaction facility in the form of an Internet-based compliance assurance facility 10. The compliance assurance facility 10 includes one or more of a number of types of front-end servers, namely page servers 12 that deliver web pages (e.g., markup language reports), picture servers 14 that dynamically deliver images to be displayed within Web pages, CGI (Common Gateway Interface) servers 18 that provide an intelligent interface to the back-end of facility 10, and search servers 20 that handle search requests to the facility 10. E-mail servers 21 may provide, inter alia, automated e-mail communications to users of the facility 10. The back-end servers may include a database engine server 22, a search index server 24 and a payment (e.g., credit card and/or subscription) database server 26, each of which may maintain and facilitate access to a respective database. Facility 10 may also include an administrative application server 28 configured to provide various administrative functions.

The network-based compliance assurance facility 10 may be accessed by a client program 30, such as a browser (e.g., the Internet Explorer distributed by Microsoft) that executes on a client machine 32 and accesses the facility 10 via a network such as, for example, the Internet 34. Other examples of networks that a client may utilize to access the compliance assurance facility 10 include a wide area network (WAN), a local area network (LAN), a wireless network (e.g., a cellular network), or the Plain Old Telephone Service (POTS) network.

### Database Structure

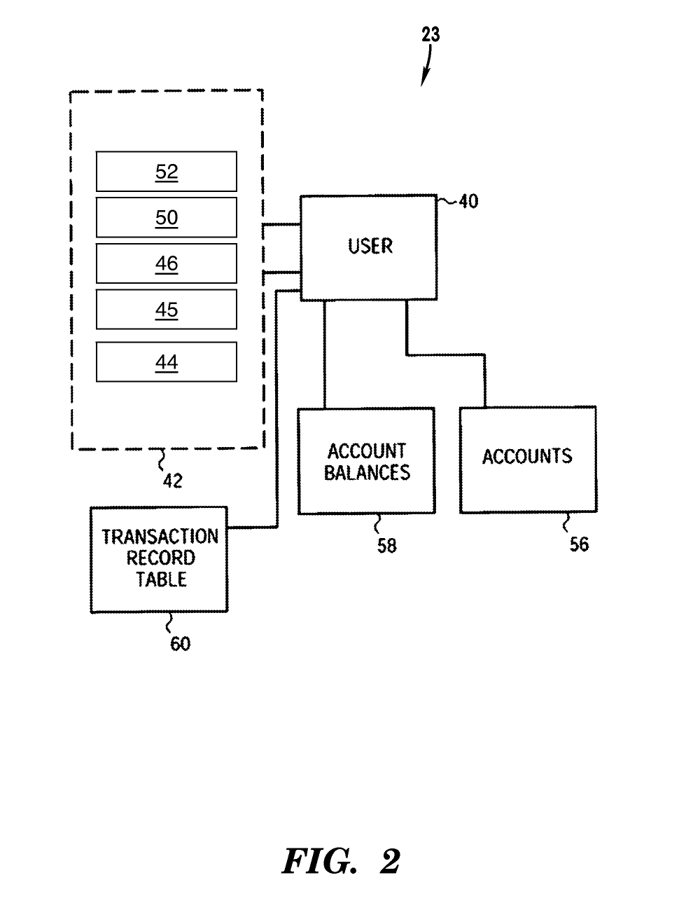

FIG. 2 is a database diagram illustrating an exemplary database 23, maintained by and accessed via the database engine server 22, which at least partially implements and supports the compliance assurance facility 10. The database 23 may, in one embodiment, be implemented as a relational database, and includes a number of tables having entries, or records, that are linked by indices and keys. In an alternative embodiment, the database 23 may be implemented as collection of objects in an object-oriented database.

As shown, central to the database 23 is a user table 40, which contains a record for each user (e.g., individual dealerships) of the compliance assurance facility 10. The database 23 also includes tables 42 that may be linked to the user table 40. Specifically, the tables 42 may include sales representative tables 44 listing the various sales representatives associated with a particular user. Tables 42 may also include prospective customer tables 45 and source material (e.g., source document) content tables 46, 50, etc., for various customer documents such as drivers licenses, credit reports, etc. Additional tables 52, etc., may be used to store additional information generated by the facility 10, such as test drive data, financing data, proof of income, residency, etc., associated with the various customers. A user record in the user table 40 may be linked to multiple documents that are being, or have been, captured and/or generated via the facility 10 and for which records exist within the report tables 42. A number of other tables may also be linked to the user table 40, such as an accounts table 56, an account balances table 58 and a transaction record table 60.

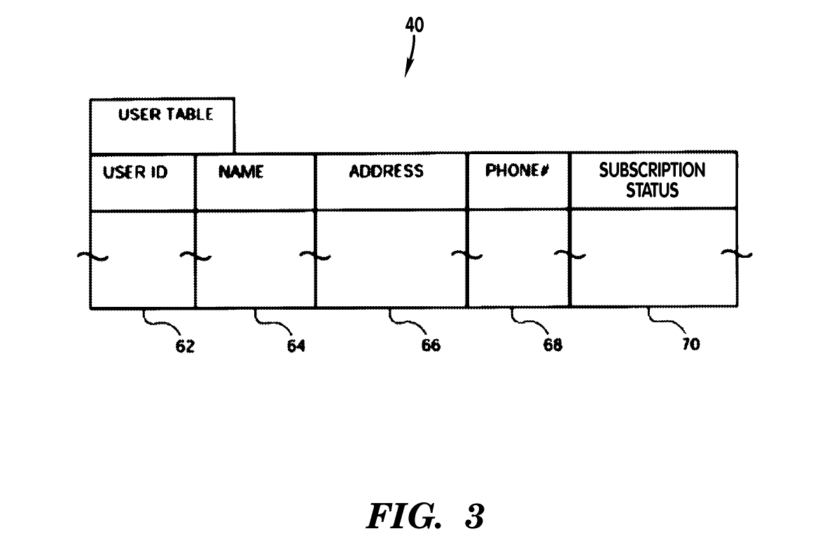

FIG. 3 is a diagrammatic representation of an exemplary embodiment of the user table 40 that is populated with records, or entries, for each user of the compliance assurance facility 10. As shown, table 40 includes a user identifier column 62 that stores a unique identifier for each user. A name column 64 may store a name (e.g., dealership's name) for each user/subscriber. An address column 66 may store full address information and/or other contact information for each user, e.g. a street name and number, city, zip code, state, email address, etc. A phone number column 68 stores a telephone number for each user. A subscription status column 70 may store, for each user, a value identifying the user's subscription status. That is, different values may be assigned to indicate whether a user has a currently valid subscription, has an expired subscription (and which may provide only limited access to facility 10), and/or is accessing the facility on a pay-as-you-go basis such as via credit card, etc. It will be appreciated that any information other than that described above may populate the user table 40 without loss of generality.

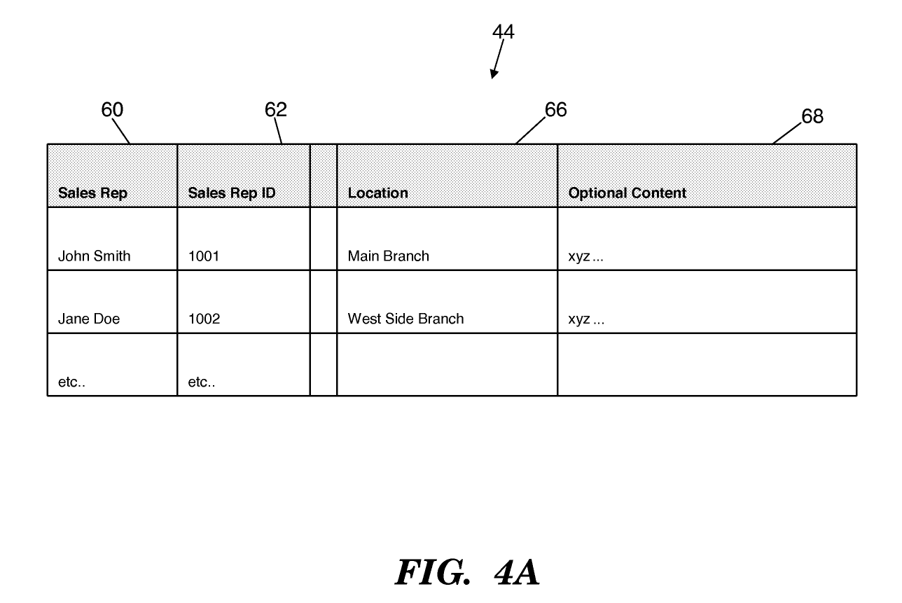

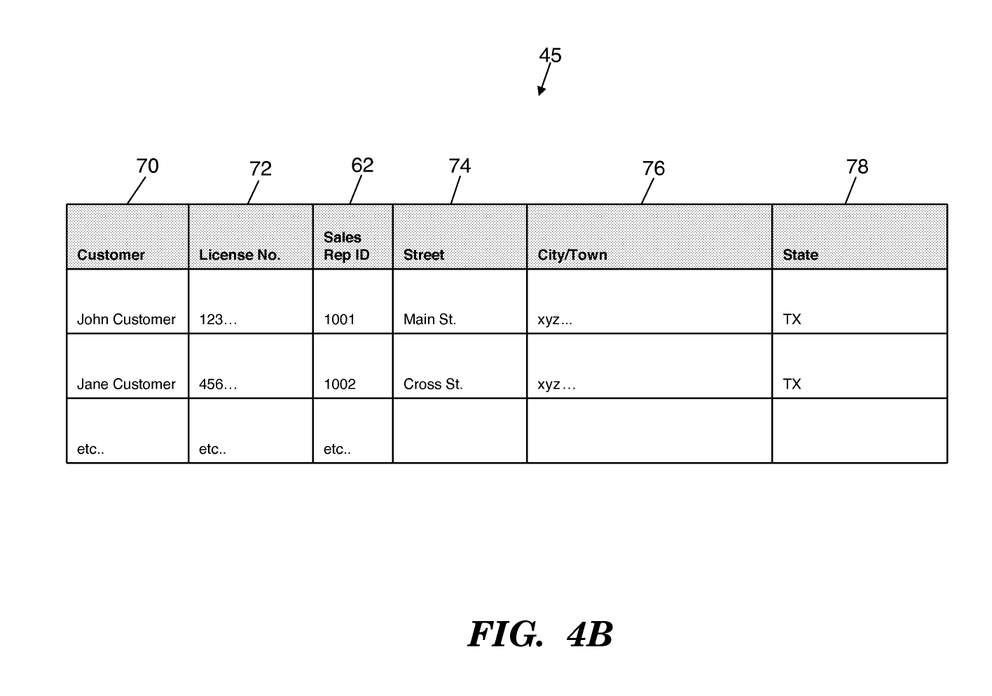

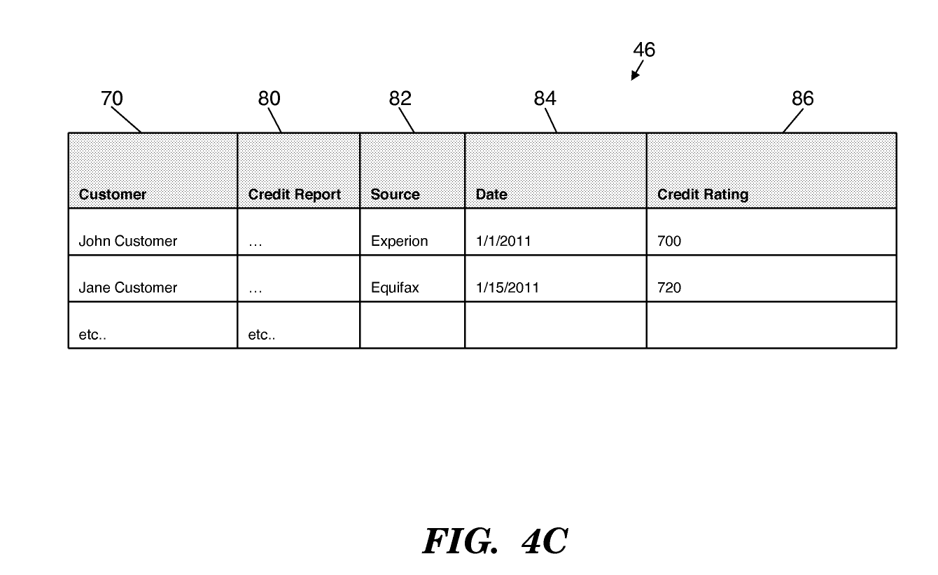

FIGS. 4A-4C are diagrammatic representations of exemplary embodiments of tables 44, 45 and 46 which are populated with document/report records during use of the compliance assurance facility 10. Referring now to FIG. 4A, sales representative table 44 is configured to store data associated with the individual sales representatives working at a particular user (dealership). This table includes, for example, a name column 60 to identify the name of the sales representative, a Sales Rep ID column 62, a location column 66 to identify the particular facility at which the sales rep works, and one or more columns 68, etc., to store various additional information for each sales rep, as desired.

Referring to FIG. 4B, customer table 45 may be configured to store various data associated with dealership customers. One or more of these columns may be populated automatically upon OCR (Optical Character Recognition) capture of the customer's driver's license, as will be discussed in greater detail hereinbelow. For example, customer name column 70, license number column 72, and address columns 74, 76 and 78 (street, city/town, state) may all be populated with information obtained from the customer's driver's license. Sales Rep ID column 62 may be populated with the ID (e.g., from Table 44) of the particular sales representative working with the customer.

As shown in FIG. 4C, an exemplary customer content table 46 may be used to store and/or provide pointers to additional content associated with the customers, such as credit report data, etc. For example, table 46 may include a customer name column 70, and a credit report column 80 populated with either the customer's credit report or with pointers to the location of the credit report. Additional columns may include source, date and credit rating columns 82, 84, 86, to store the source (e.g., Experion, etc.), date and rating of the report, respectively.

Any number of additional tables may be provided, as may be desired for particular applications. While such additional tables may use a format similar to that described with respect to FIGS. 4A-4C, those skilled in the art will recognize, in light of the instant disclosure, that substantially any database management approach may be used, without departing from the scope of the present invention.

Process

As mentioned hereinabove, embodiments of the present invention provide an automated system and method for capturing, storing, and ensuring compliance with the capture, generation and retention of customer credit information. These embodiments enable such compliance assurance in a real-time, web-based, client-server environment, such as on a subscription or pay-as-you-go basis. While the present invention is discussed within the environment of the exemplary compliance assurance facility 10, it will readily be appreciated that the present invention may be used in any number of environments including network and on-line based, or stand-alone transaction facilities based at the user's facilities.

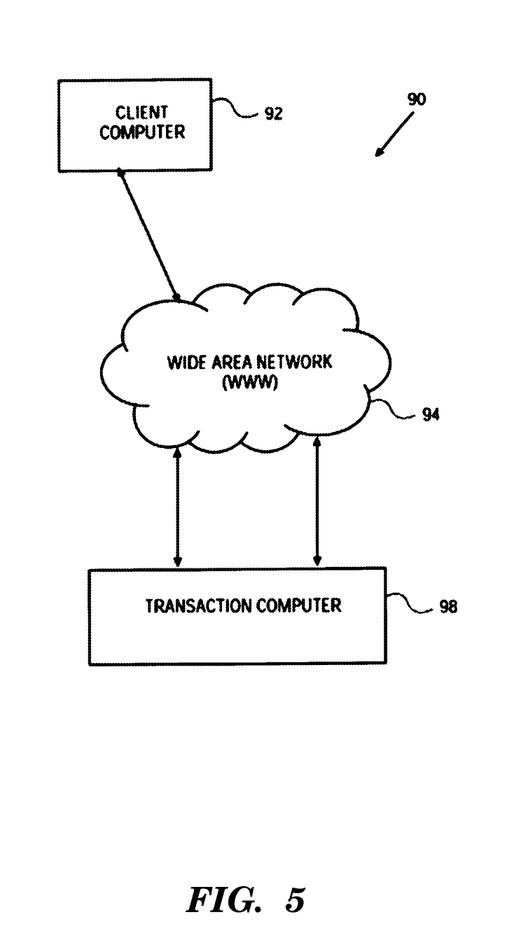

FIG. 5 is a simplified block diagram of a system 90 for customer credit compliance assurance system in accordance with an exemplary embodiment of the present invention. In this embodiment, a client computer 92 is coupled to a transaction computer 98 via a communications network (e.g. a wide area network) 94. The client computer 92 represents a device that allows a user to interact with the compliance assurance facility 10 or any other transaction facility 98. In one embodiment, the client computer 92 presents to the user a compliance assurance interface for capturing, storing and aggregating customer information using the transaction computer 98.

The transaction computer 98, which supports a compliance assurance facility such as shown at 10 of FIG. 1, handles transactions between various participants of the facility 10 including the user of the client computer 92. In one embodiment, the transaction computer 98 may initially receive the personal information of the participant from the client computer 92, and generate a subscription result which determines whether, and to what extent, the user is granted access to the facility 10. The transaction computer then facilitates the generation of custom output/reports in accordance with various user interfaces presented by the computer 98, via the client computer 92, to the user.

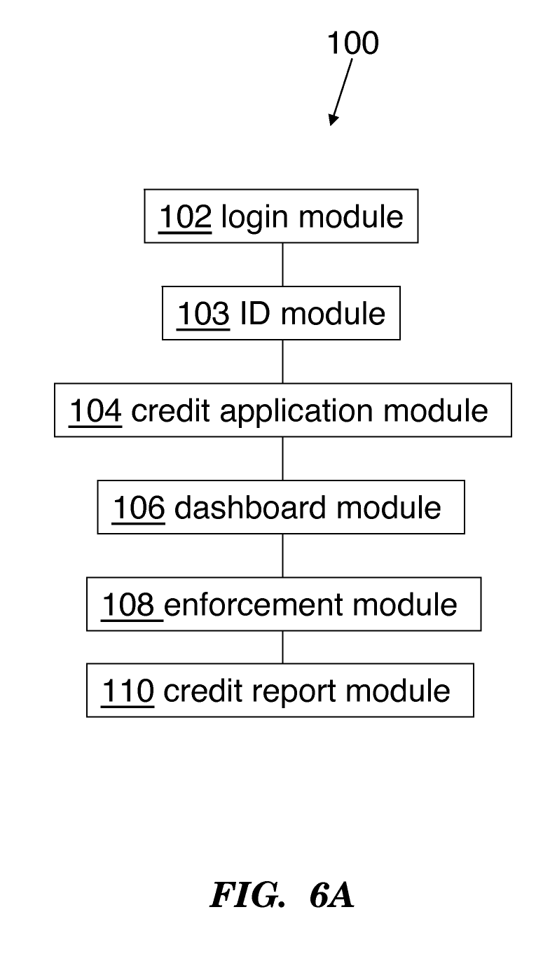

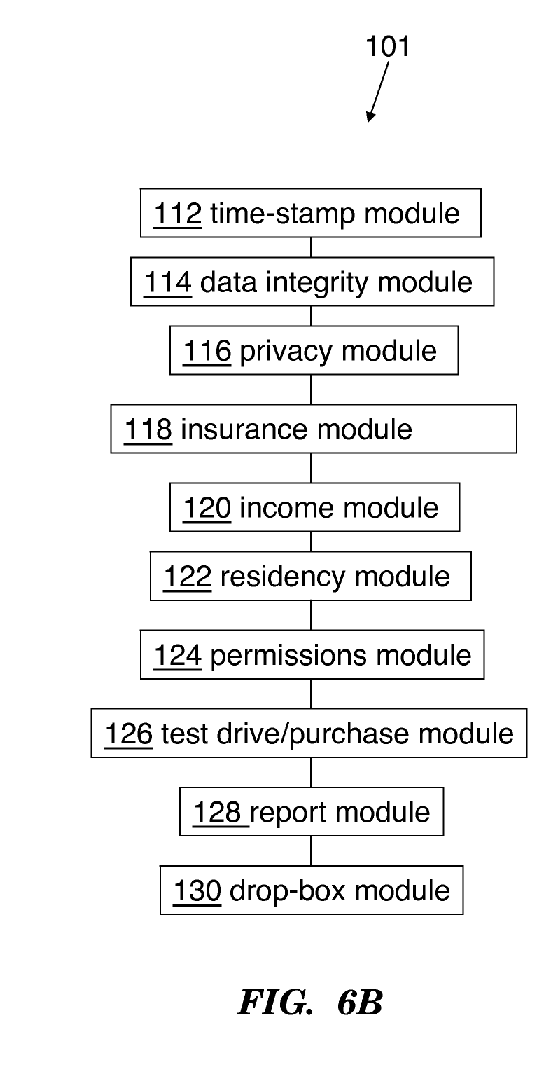

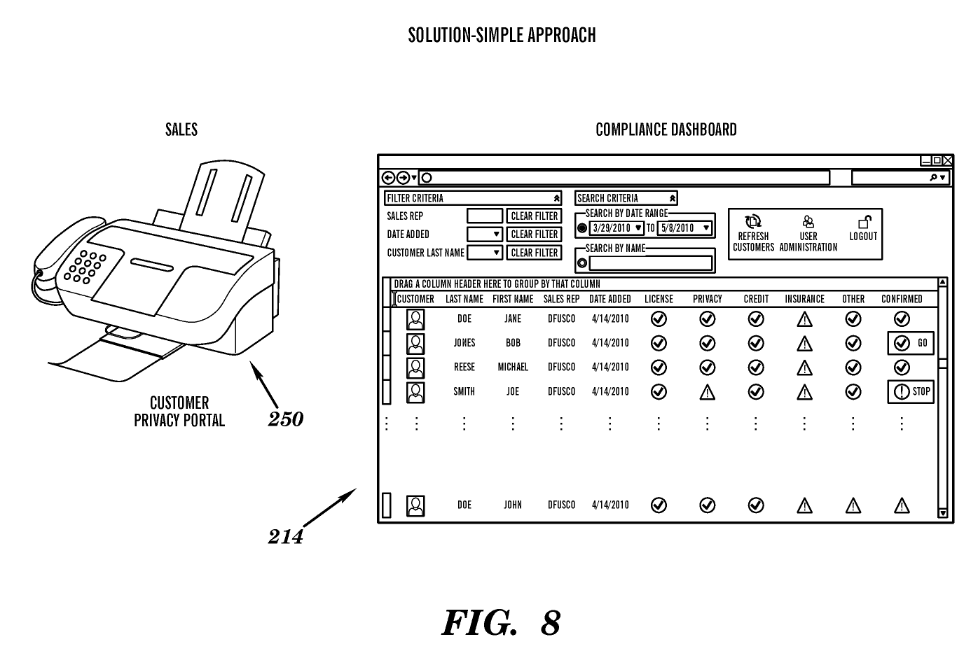

FIGS. 6A and 6B show a series 100, 101 of interfaces/modules, such as may take the form of a series of objects (or methods), that may be implemented by the compliance assurance facility 10, e.g., in combination with the various tables of database 23, for the purposes of acquiring and handling customer credit information during a motor vehicle sales cycle. Where applicable, the series 100 of modules shown in FIGS. 6A and 6B will be described with reference to exemplary representations of the various interfaces as shown in FIGS. 8-11.

As shown, series 100 includes a login module 102, configured to generate a login interface through which a user of the facility 10 provides at least a user identifier and associated password. The user may also be requested to pay a fee for the subscription process. An identification (ID) module 103 is configured to generate a data capture interface, such as shown at 200 in FIG. 5. Module 103 interacts with the various tables of database 23 (FIG. 1) to enable interface 200 to display various tabs, including those shown at 202 and 204, to enable a user to scan or manually enter customer license or other ID data. This captured ID data may then be associated with an electronic customer file, e.g., via storage in the various tables 42 (FIG. 2). Additional tabs, such as shown at 206, may be generated by credit application module 104 to facilitate the capture of a customer credit application, and association of the captured credit application with the electronic customer file via storage in tables 42. In some embodiments, e.g., when permitted by applicable laws, credit application module 104 may be optionally configured to permit the customer to electronically execute and store the credit application, to help reduce or eliminate the need to store paper copies of the credit application(s).

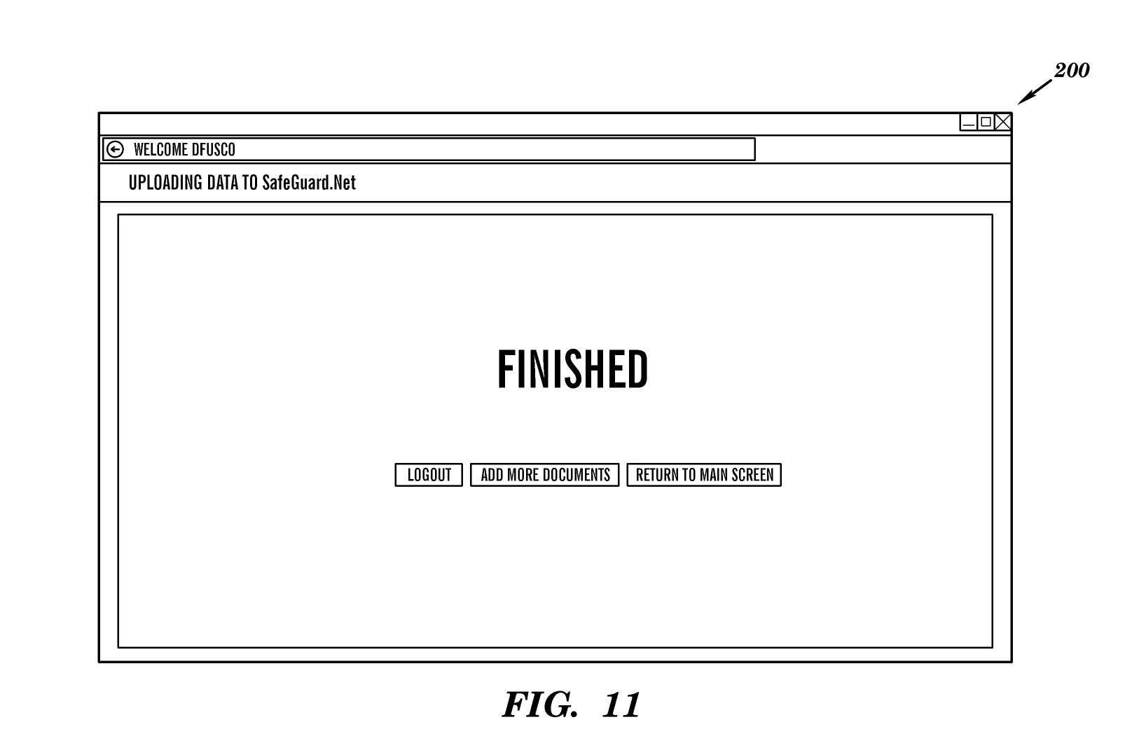

Returning to FIG. 6A, dashboard module 106 is configured to generate an electronic dashboard interface such as shown at 214 of FIG. 11. This exemplary dashboard interface 214 is configured to track and selectively display status of the electronic customer file, e.g., for a plurality of customers. In the exemplary embodiment shown, dashboard 214 provides a visual/graphical indication of whether or not driver's license and credit application data have been captured for each customer.

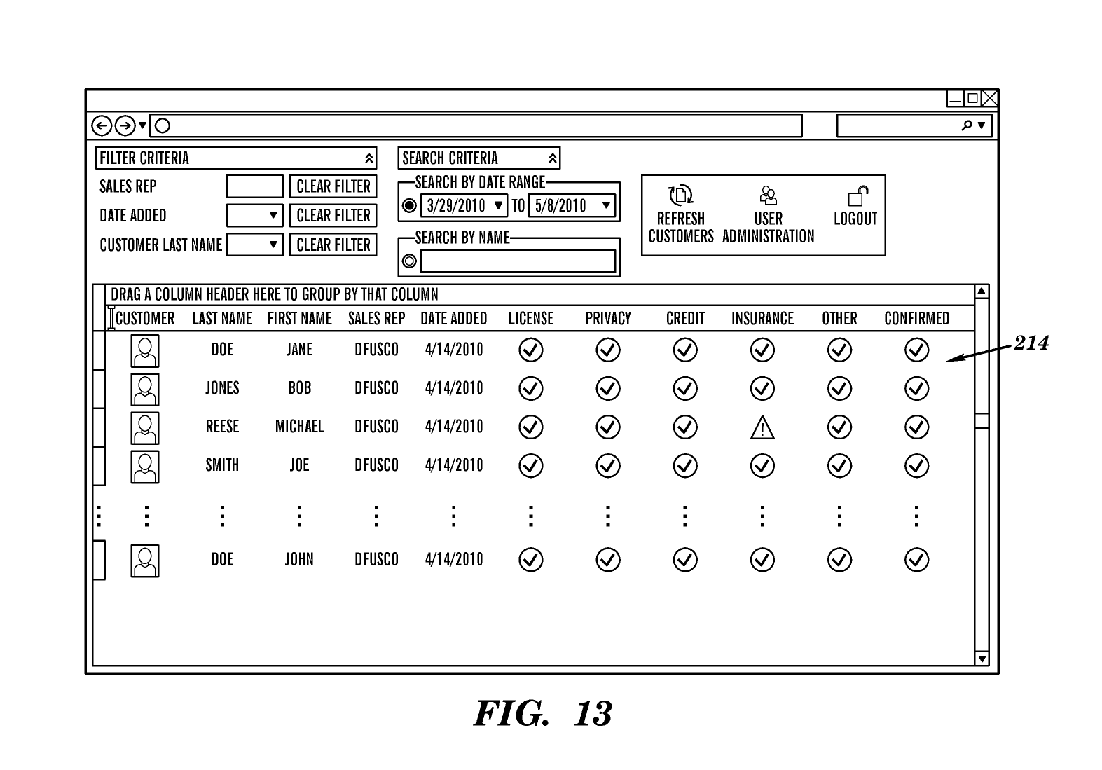

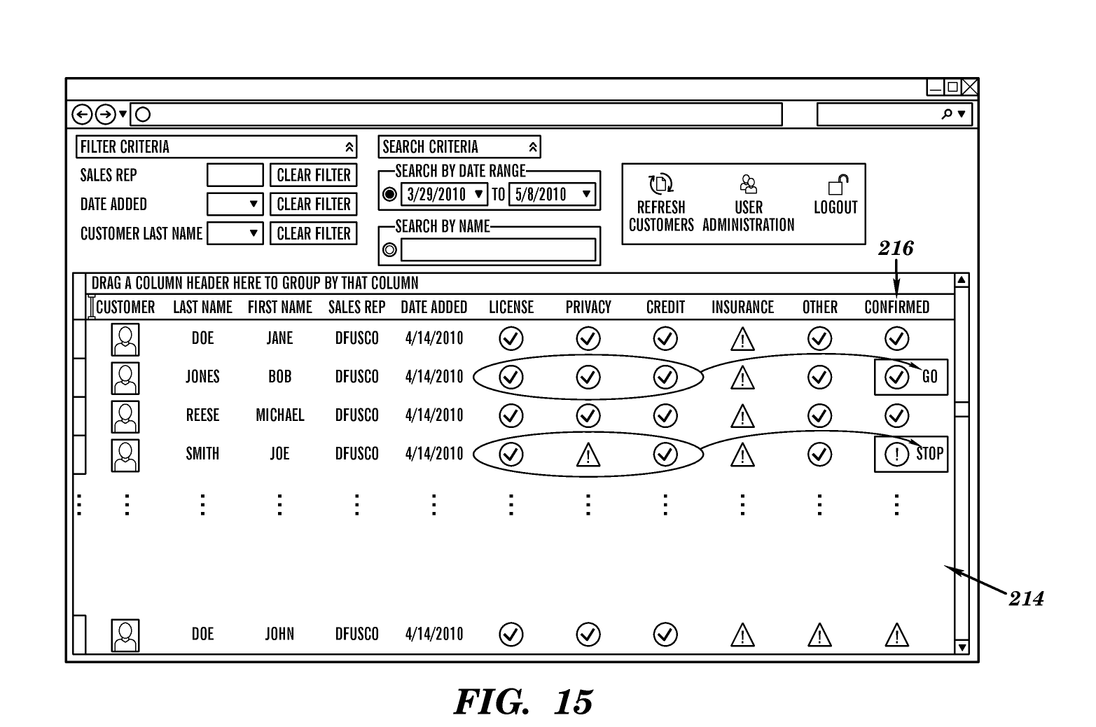

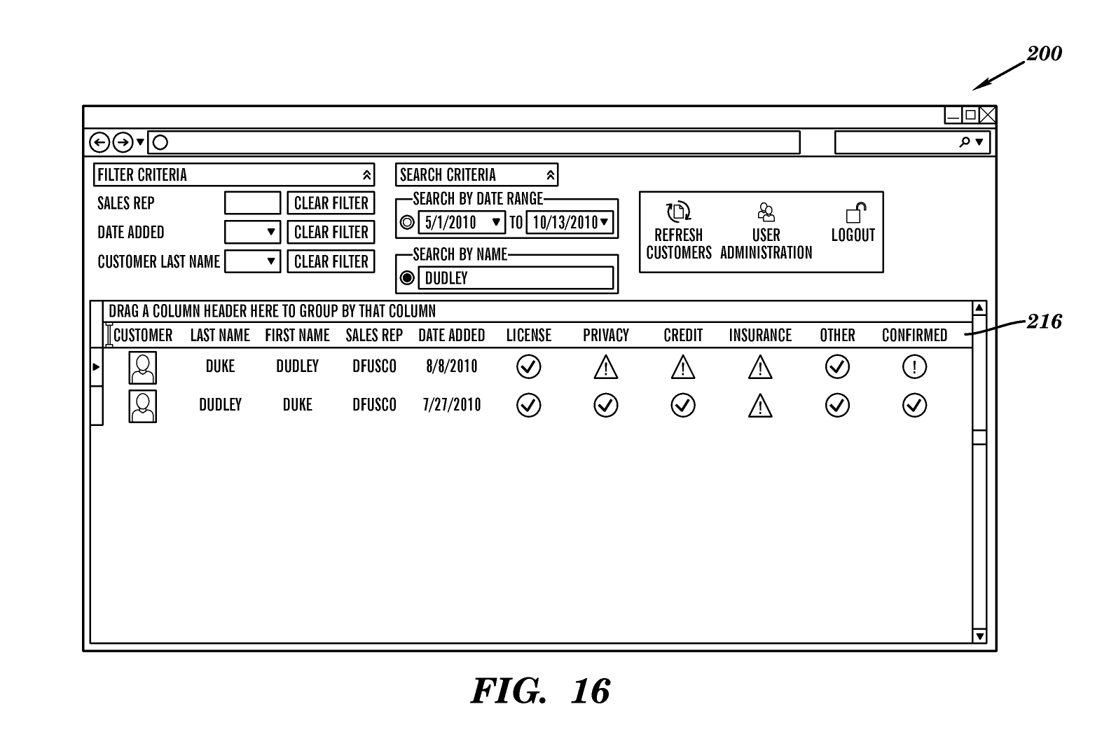

Enforcement module 108 (FIG. 6A) is configured to selectively permit and prevent acquisition of a credit report (and/or other documents) for the customer in accordance with the status of the electronic customer file. As best shown in FIG. 13, enforcement module 108 may generate a visual/graphical indication at 216 on electronic dashboard interface 214, of whether or not enough data has been captured to permit acquisition of a customer's credit report. In particular embodiments, module 108 is also configured to generate a visual indicator on a credit report interface 220 (FIGS. 15, 16), e.g., in the form of a button 222 that may be alternately activated (FIG. 16) and deactivated (grayed out) (FIG. 15), as discussed hereinbelow.

As also shown in FIG. 6A, series 100 may also include a credit report module 110 configured to, upon permission by the enforcement module 108, facilitate the acquisition and association of a customer credit report with the electronic customer file/tables 42. As best shown in FIGS. 15 and 16, module 110 may provide this functionality by generating a credit report interface 220. As mentioned above, when module 110 activates button 222, as shown in FIG. 16, a user may use interface 220 to capture of the customer's credit report.

Turning now to FIG. 6B, a series 101 of optional interfaces/modules will be shown and described. It should be noted that embodiments of the present invention may use any one or more of these optional modules in substantially any combination, without departing from the scope of the present invention. As shown, series 101 includes a time stamp module 112 configured to apply time-stamps to the various items associated with the electronic customer file/tables 42. Module 112 may be used in combination with a data integrity module 114 configured to ensure that the items associated with the electronic customer file are maintained for a predetermined time period subsequent to the time-stamps. Those skilled in the art will recognize that the predetermined period of time may be sufficient to satisfy applicable legal requirements for record-keeping.

As also shown, series 101 may include privacy, insurance, income, and residency modules 116, 118, 120, and 122, configured to capture and associate with the customer file(s), privacy statements, motor vehicle insurance information, proof of income information, and proof of residency information, respectively. As shown in FIG. 5, in particular embodiments, these modules may be configured to populate interface 200 with tabs, such as privacy, insurance, income, and residency tabs 207, 208, 209, and 210, respectively, to facilitate information capture as discussed above. In some embodiments, e.g., when permitted by applicable laws, privacy module 116 may be optionally configured to permit the customer to electronically execute the privacy statement, to help reduce or eliminate the need to store paper copies thereof.

Turning back to FIG. 6B, series 101 may include a permissions module 124 configured to operate in conjunction with database 23 (FIG. 1) to provide selective access to the server by one or more users at one or more client computers 32, 92. In this regard, it should be recognized that embodiments of the present invention are configured to handle and maintain electronic customer files for a plurality of customers. Moreover, the system 10 may be configured to associate each of the plurality of customer files with a particular user (e.g., with a particular motor vehicle dealership). System 10 may also associate each of the customer files with one or more sales representatives employed by, or otherwise associated with, the particular user. The permissions module 126 may thus be configured to provide selective access to the system 10, 98, by one or more users at one or more client computers 32, 92. For example, a general manager at a dealership may be permitted to access data only for those customers associated with that particular dealership. Similarly, a sales representative at a particular dealership may only be permitted to access data for those customers associated with that particular sales representative.

A test drive/purchase module 126 may be configured to capture and associate with the electronic customer file, information pertaining to whether the customer test drove a motor vehicle. The test drive/purchase module 126 may also be configured to capture and associate with the electronic customer file, information pertaining to whether the customer purchased a motor vehicle. As also shown, a report module 128 may be configured to generate various reports displaying status, e.g., via user interface 230, of electronic customer files for any one said plurality of customers. Those skilled in the art will recognize that report module 128 may be configured to sort the information of the database 23 in accordance with any number of search parameters, to generate reports relating to substantially any aspect of the information stored in the tables 40, 42, 56, 58, 60, etc., of database 23.

In still another optional aspect of the present invention, the various embodiments thereof may be provided with an electronic drop-box module 130 configured to encrypt and associate any of the items associated with any particular electronic customer file with a URL configured for selective access by a motor vehicle financing entity. This module 130 may then place the URL into an email, e.g., via email server(s) 21 (FIG. 1), and send the email to the financing entity.

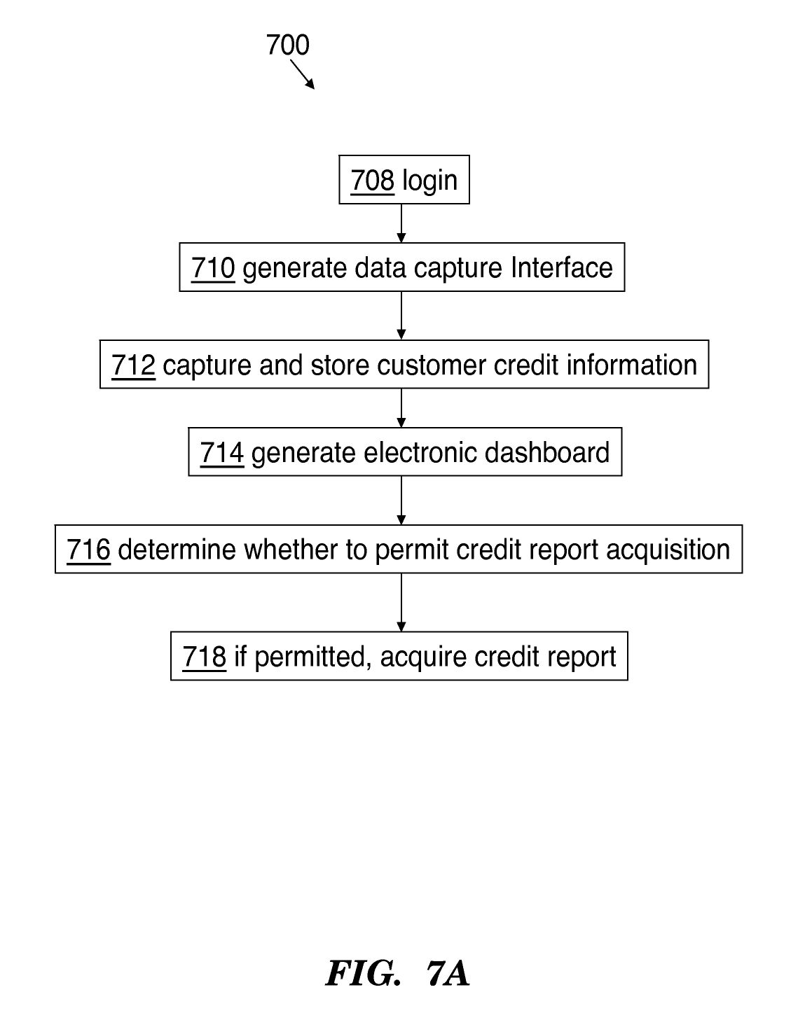

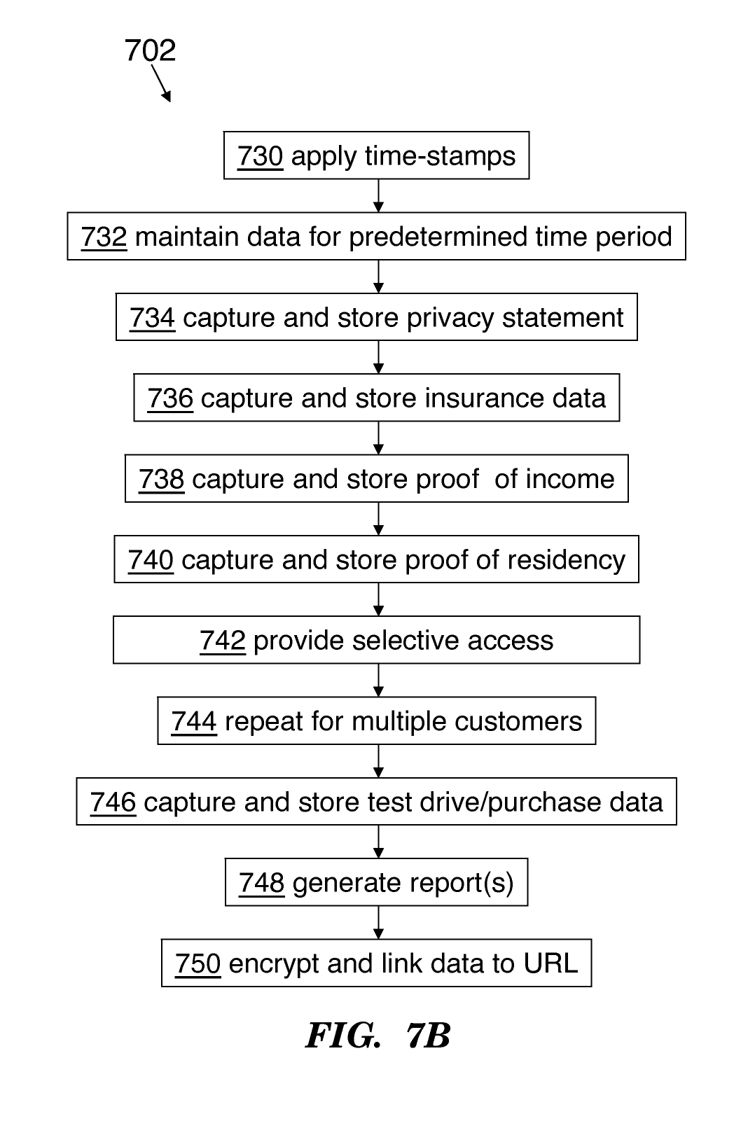

A method for customer credit information acquisition, aggregation, and maintenance, during a motor vehicle sales cycle, in a client-server environment using a network-based transaction facility, such as the compliance assurance facility 10, will now be described as illustrated by the flow chart of FIGS. 7A and 7B. As shown in FIG. 7A, the method 700 commences with communicating 708 user interface information to a user of the transaction facility at client 32 (FIG. 1). More specifically, the user interface information may provide a login interface via login module 102, described above with reference to FIG. 6A. Subsequent to the login by the user, at 710 the user is provided with a data capture interface, such as shown and described with respect to FIG. 5, prompting the user to enter, and by which the system may capture and store a customer's ID (e.g., driver's license) and credit application information, e.g., using ID and credit application modules 103, 104 (FIG. 6A). At 714, the system generates and configures an electronic dashboard 200 (FIG. 8) to track and selectively display status of the electronic customer file. At 716, the system selectively determines whether to permit or prevent (e.g., using enforcement module 108 of FIG. 6A) acquisition of a credit report for the customer in accordance with the status of the electronic customer file. When permission is granted by the enforcement module 108, at 718, the system acquires and stores a credit report for the customer.

Optional aspects of the method of FIG. 7A and shown and described with respect to 702 of FIG. 7B. It should be recognized that embodiments of the present invention may use any one or more of these optional aspects in substantially any combination, without departing from the scope of the present invention.

At 730, they system may apply time-stamps to the items associated with the electronic customer file, e.g., using time-stamp module 112 (FIG. 6B). At 732, these items are maintained for a predetermined time period subsequent to the time-stamps, e.g., using data integrity module 114. At 734, privacy module 116 is used to capture and store a privacy statement executed by the customer. At 736, insurance module 118 is used to capture and store automobile insurance information for the customer. At 738, income module 120 is used to capture and store proof of income information for the customer. At 740, residency module 122 is used to capture and store proof of residency information for the customer. At 742, permissions module 124 may be used to provide selective access to the server by one or more users at one or more client computers 32, 92, as described hereinabove. At 744, the system repeats any of the above-described aspects of methods 700, 702 to capture and maintain data in electronic customer files for a plurality of customers.

At 746, test drive/purchase module 126 is used to capture and store information pertaining to whether the customer test drove and/or purchased a motor vehicle. At 748, report module 128 is used to generate a report(s) displaying status of electronic customer files for any one the plurality of customers. At 750, drop-box module 130 is used to encrypt and associate any of the items associated with the electronic customer file with a URL for selective access by a motor vehicle financing entity.

In summary, it will be appreciated that the above described modules and interfaces, and underlying technologies, provide a convenient vehicle for credit information acquisition, aggregation, and maintenance, during a motor vehicle sales cycle, in a real-time, multi-user environment using a seamlessly integrated network-based transaction facility.

Having shown and described various embodiments of the present invention the following is a more detailed explanation of operation of a particular exemplary embodiment thereof.

Referring now to FIG. 8, embodiments of system 10 may be implemented, using a sales interface (e.g., Customer Privacy Portal) 250 in the form of a scanner communicably coupled to a client computer 32, 92, which provides a convenient means for collecting the required information. These embodiments also include the COMPLIANCE DASHBOARD 214, discussed hereinabove, which may sit open on the desktop of client computers 32, 92, of managers and other stakeholders in the user's business, giving them the ability to help ensure the appropriate behavior and documentation is being collected and protected.

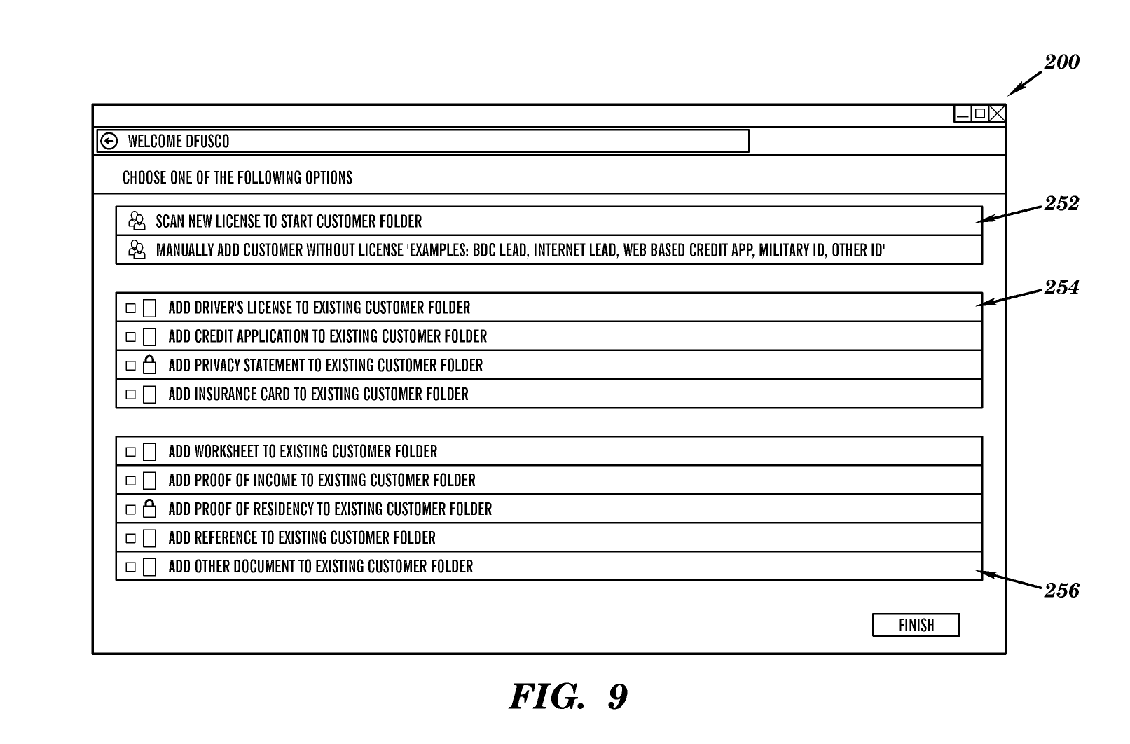

In use, instead of walking to a copy machine or somewhere else with various customer documents and creating a potential liability as discussed above, and then hoping that they will be correctly filed away for 7 years as required, a sales representative may simply walk up to customer privacy portal/scanner 250 and click on SCAN LICENSE, which will open interface 200 (FIG. 9) on the user's computer. As shown, interface 200 includes three sections. Section 252 may be used to add a new customer, while section 254 may be used to add various compliance documents. The bottom section 256 is configured to add various optional or “convenience” documents, to facilitate the transaction. For example, the above-referenced proof of income or proof of residency information may be added using this section 256.

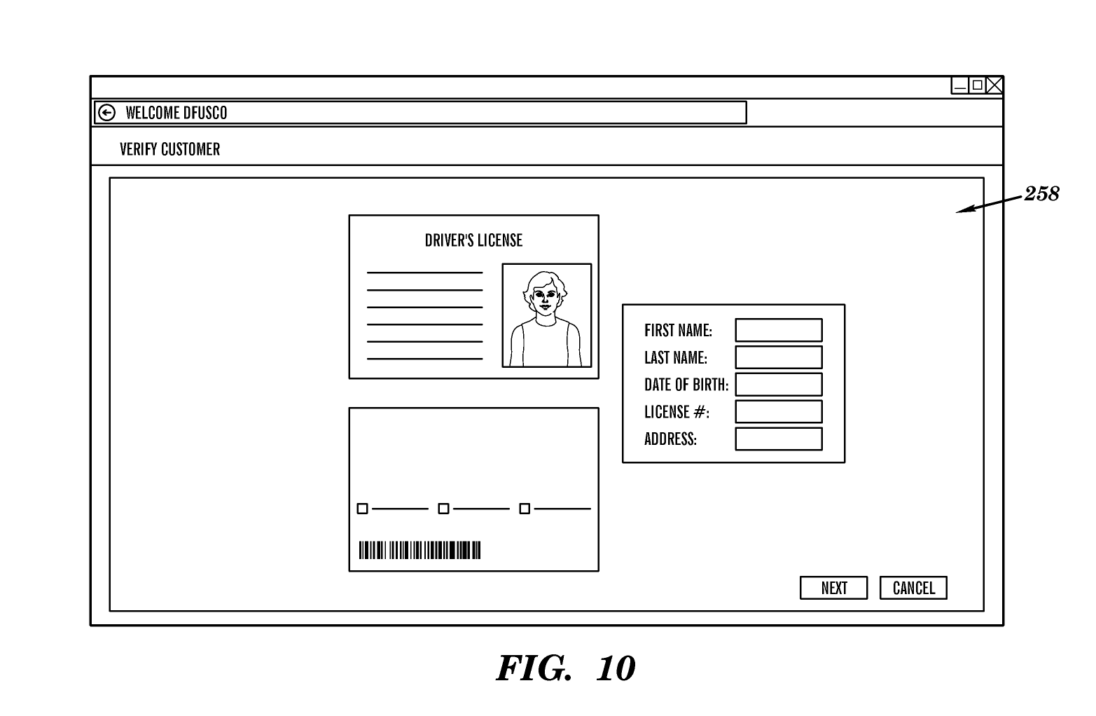

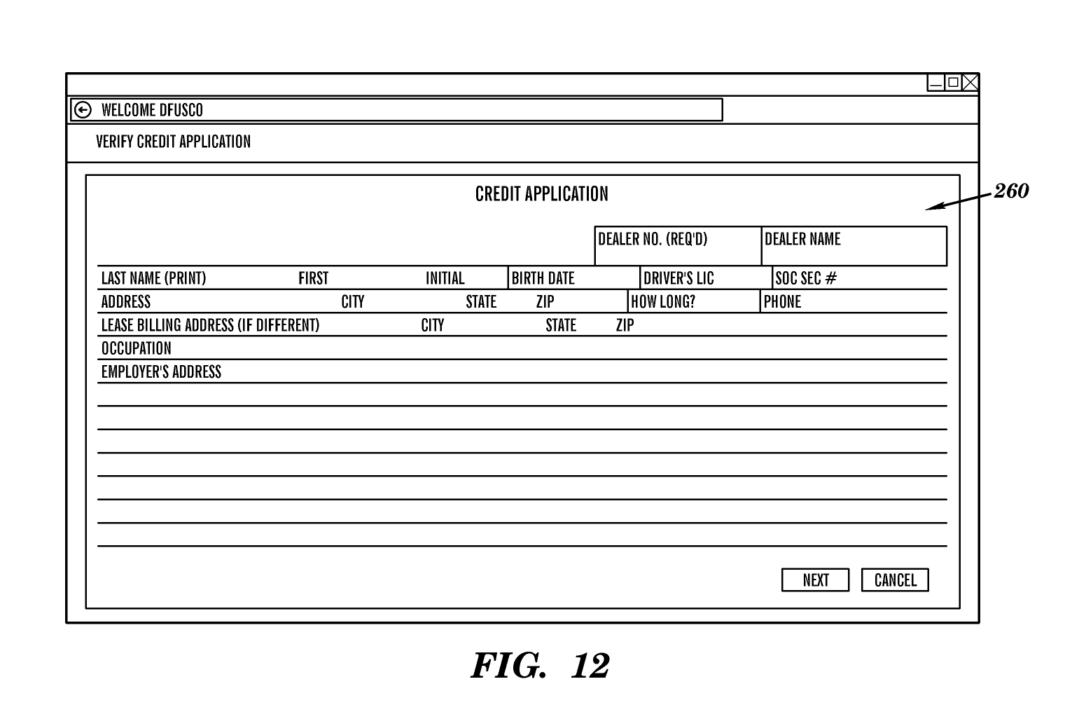

When a user selects SCAN new license (section 252, FIG. 9), the system may scan the front and back, and OCR the information on the front, such as shown at 258 of FIG. 10, and create a 7 year folder for that customer. Upon completion, the user interface may generate suitable indication, such as Finished screen 260 (FIG. 11). The user may then click log out (FIG. 11) and get the keys to a vehicle for the customer's test drive. Additional documents, such as a credit application, may be added by going back to screen 200 (FIG. 9), selecting the appropriate tab, such as Add Credit App to existing customer, and dropping that document into the scanner 250 (FIG. 8), which may them be presented on the screen 260 of FIG. 12.

Once a document has been scanned and/or otherwise associated with the customer's folder, the enforcement module 108 (FIG. 6A) of the system may effectively prevent the acquisition of additional copies of those documents. The system, e.g., via the data integrity module 114, may ensure that this customer information is secured, encrypted and archived for a predetermined period of time (e.g., 7 years) as may be required by law.

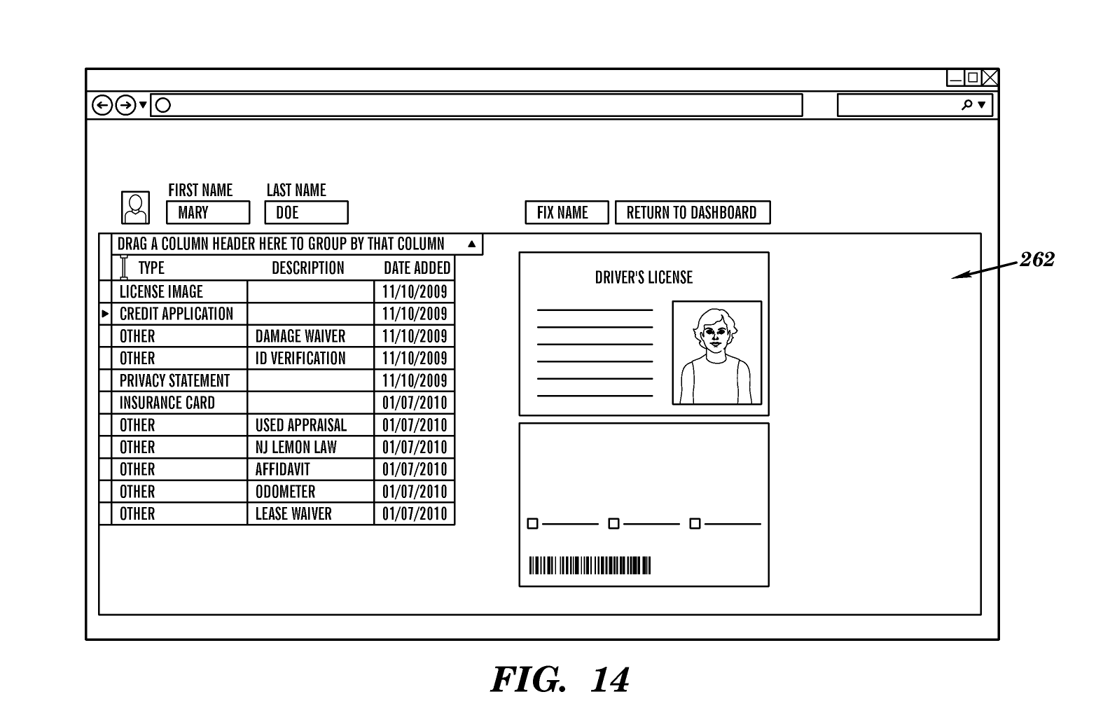

Turning now to FIG. 13, the sales manager or other similar user may access dashboard 214, which as discussed above, displays various customer information. As shown, dashboard 214 may display an image from the license for identification, name, the sales representative working with the customer, date added, and document status, e.g., with the color green for captured items, and the color yellow for missing items. The user may drill down into an individual customer folder, such as by double-clicking on the customer line, which may then render a list of all the collected documents and other information, including type, description and date added, etc., such as shown in user interface screen 262 of FIG. 14. As also shown, the user may also double-click on any of these list items to display image thereof.

Turning now to FIG. 15, when the a sales representative informs the sales manager that they need to run credit on a particular customer, the sales manager may simply view the dashboard 214 to see whether the appropriate documents have been captured and associated with the customer's file. The sales manager may view column 216, to determine whether the appropriate documents/information have been acquired, or to send the sales representative back to obtain the appropriate documents.

As discussed hereinabove, these embodiments help ensure that the appropriate documents are in the customer's file prior to running a credit check. These embodiments thus address the prior problem of the sales person skipping some of this document collection by telling the sales manager that the required paperwork is back on his desk and that the customer is in a hurry, so lets go ahead and run the credit. Unfortunately, the required paperwork often fails to reach the manager's desk, having been lost, misplaced, stolen, etc., and the dealer may be liable for that action when the customer comes back and complains or becomes the victim of identity theft.

Turning back to FIG. 15, if the required documents are all there, the sales manager is then ready to run credit. This embodiment thus provides what may be viewed as a DO NOT PASS GO approach. This approach will be described in greater detail with reference to FIG. 16.

Referring now to FIG. 16, in which two customers are displayed, one of which is confirmed with the appropriate required documents, and the other of which is non-compliant, as shown in column 216.

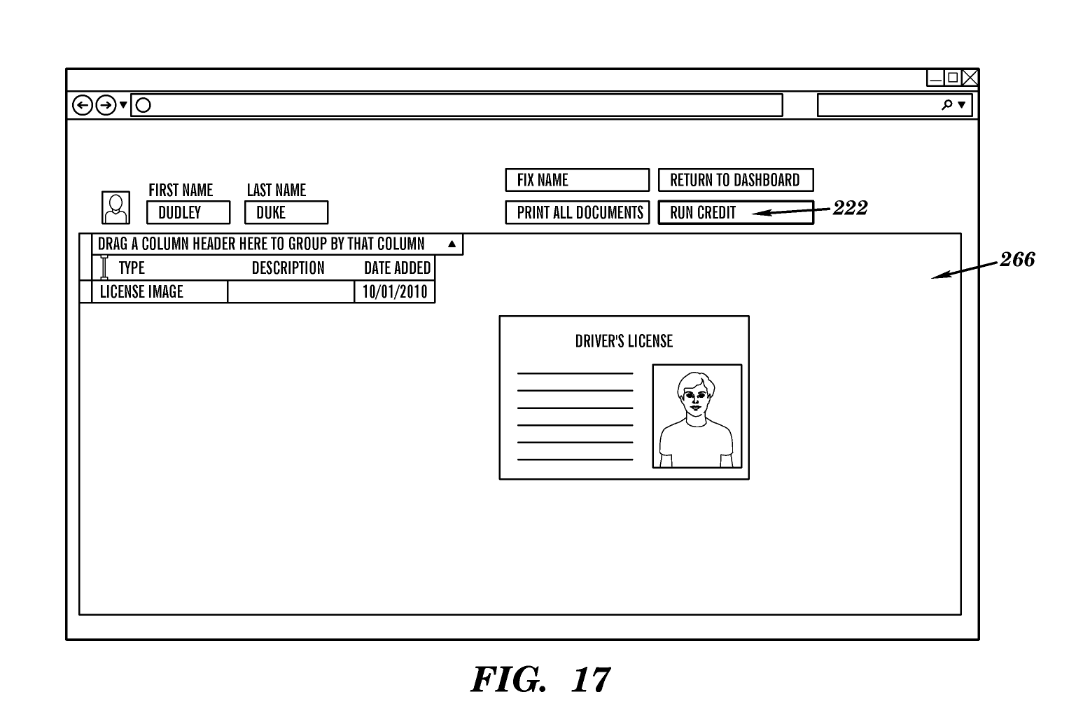

For example, as shown, if a user wanted to run credit on the first customer listed (Mr. Dudley Duke), in which only a license has been collected, the user may click on his name, which would generate the run credit screen 266 FIG. 17, in which the RUN CREDIT button 222 would be disabled. That tells the user that information is missing, and the credit system cannot be accessed, protecting both the customer and the user's business.

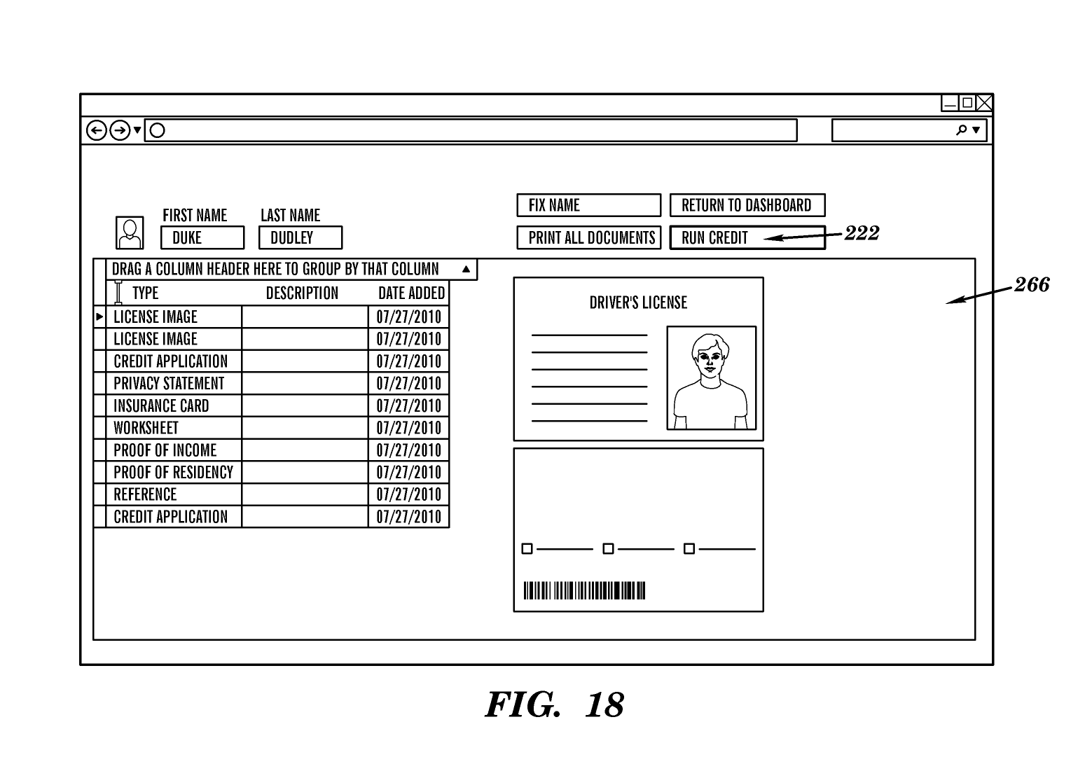

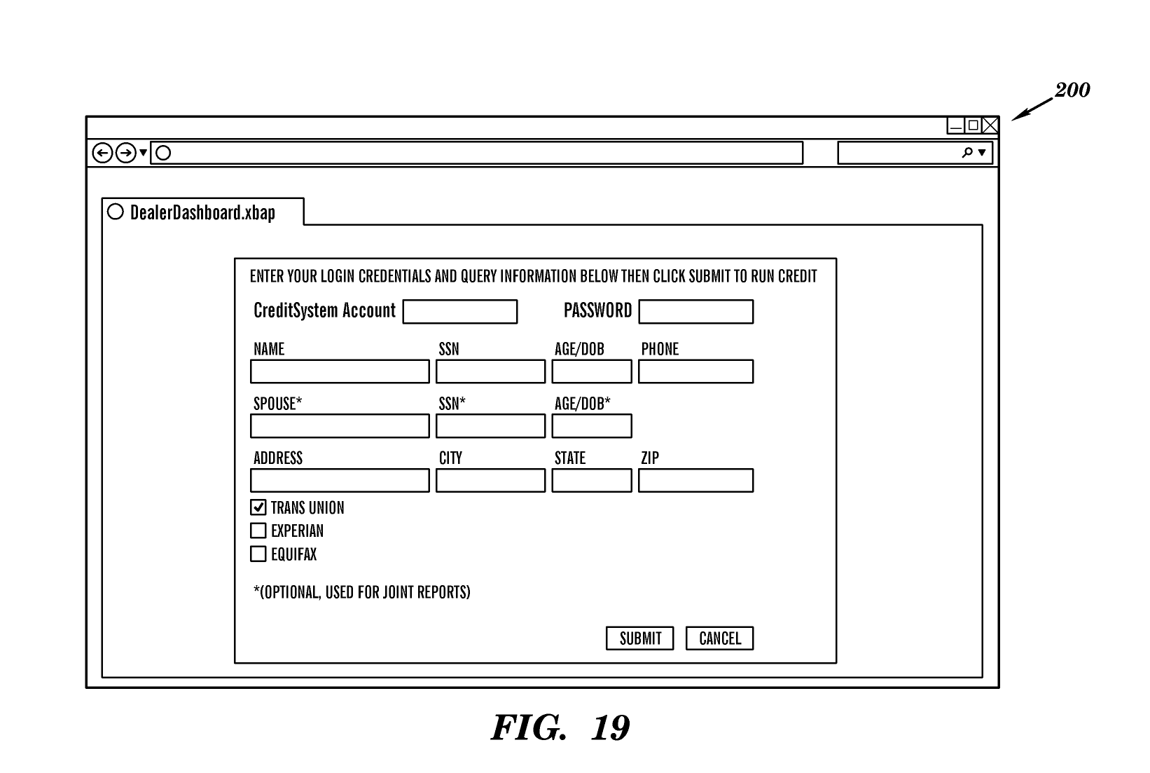

To run credit on the second customer listed in FIG. 16 (Mr. Duke Dudley), the user clicks on the record, to again generate the run credit screen 266. However, as shown in FIG. 18, since the appropriate documents have been collected, the RUN CREDIT button 222 is enabled, and clicking on it takes the user to the credit screen (FIG. 19).

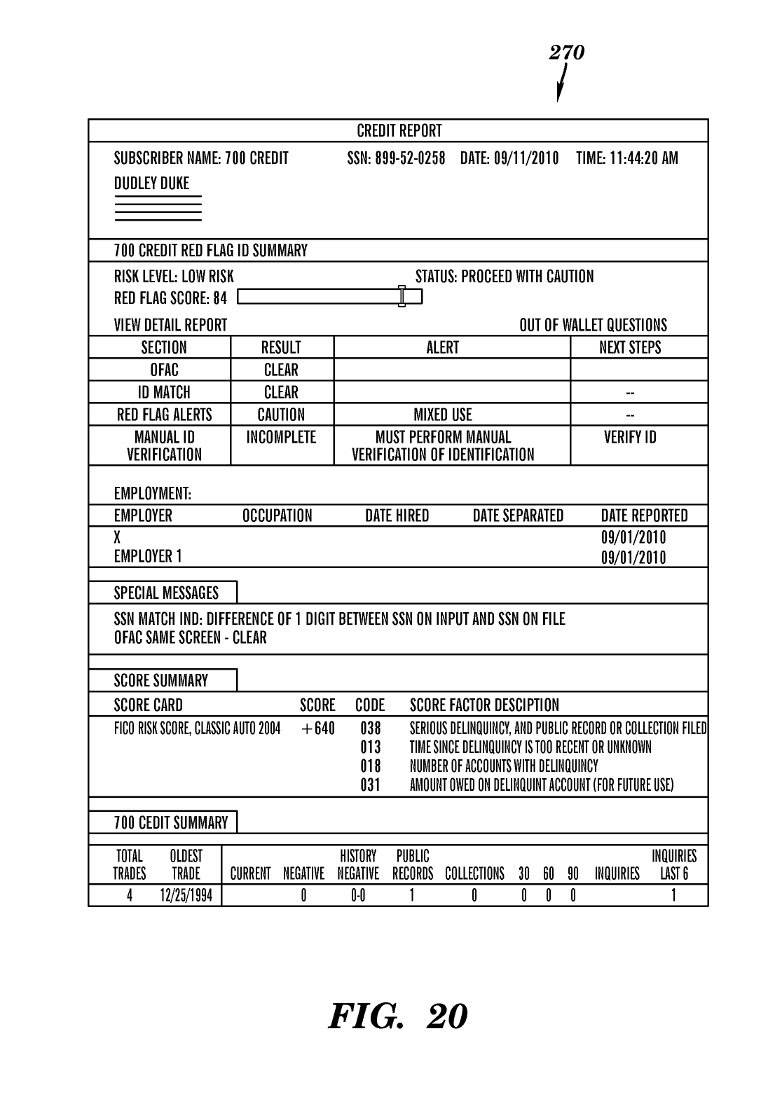

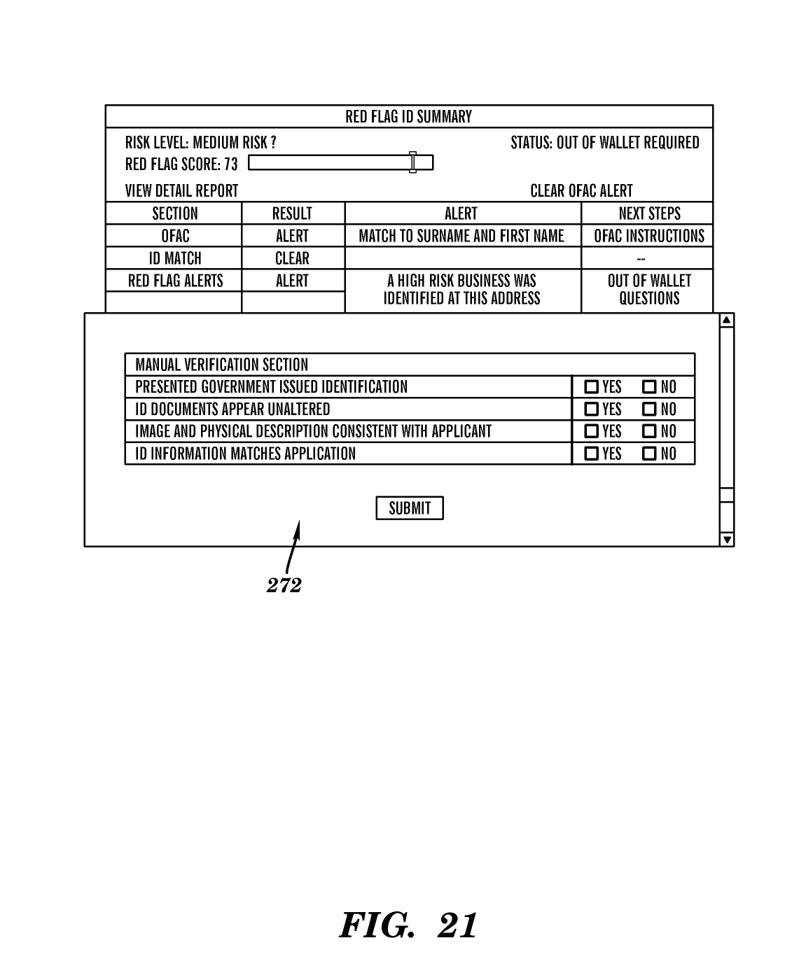

Referring now to FIG. 19, the credit screen may be automatically populated with information from the collected documents (e.g., driver's license). Other information, such as the customer's social security number may be entered manually. The user may then click SUBMIT, which renders the credit report 270 (FIG. 20), e.g., with conventional “Red Flags ID Theft” verification warnings, and manual verifications, such as shown in screen 272 of FIG. 21. The system may automatically add the Credit Report to the customer's file/folder.

As discussed above, this credit compliance assurance functionality provides various benefits to the dealer. For example, using conventional processes, when the dealer can't find a previously generated credit report, which may happen frequently in a distributed organization with new and used car buildings and/or multiple franchises, they tend to simply re-run the customer's credit. However, the dealer is charged by credit request, e.g., at a rate currently between about $2 and $5 each. Moreover, frequent credit checks tend to negatively affect the consumers credit. Embodiments of the present invention help avoid these issues by making the credit report available to any authorized users accessing the system online. As discussed above, the system may also use enforcement module 108 (FIG. 6A) to substantially prevent users from re-running credit for a particular customer more than once in a predetermined time period, e.g., 30 days, and/or generating a warning message when a user attempts to do so.

Embodiments of the present invention thus manage the process of determining whether a user can run credit, including capturing and storing the requisite information, to the capturing and storing of the credit report and document retention. These embodiments help address the prior art problems of improper document acquisition and retention, while also avoiding the problems of cost and damage to a customer's credit rating due to credit report re-runs.

Additional, optional features of various embodiments include the provision of substantially real-time snap-shot views of dealership performance. For example, a user such as a dealership general manager may wish to review sales performance over the last day, week, or month, etc.

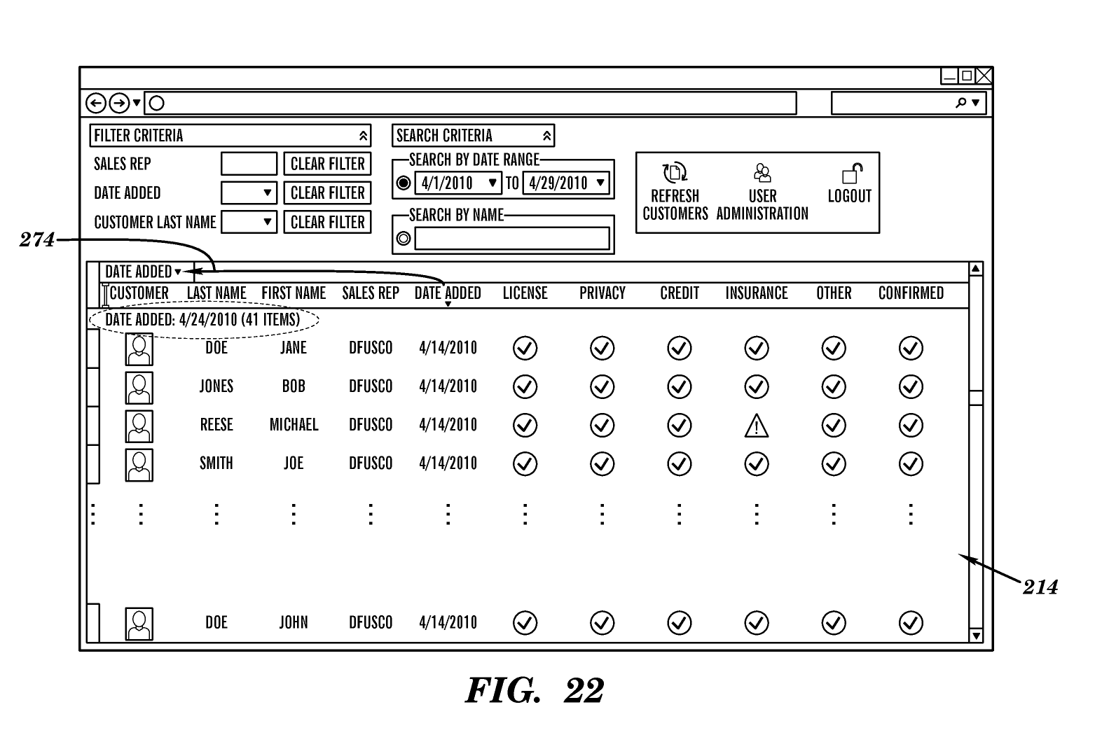

Turning now to FIG. 22, a user may want to know how many test drives were provided on a particular day. In dashboard 214, the user may click a date added and drag it to the top bar, as shown at 274, which would then categorize and subtotal by day, and in the example shown, reflects 41 test drives.

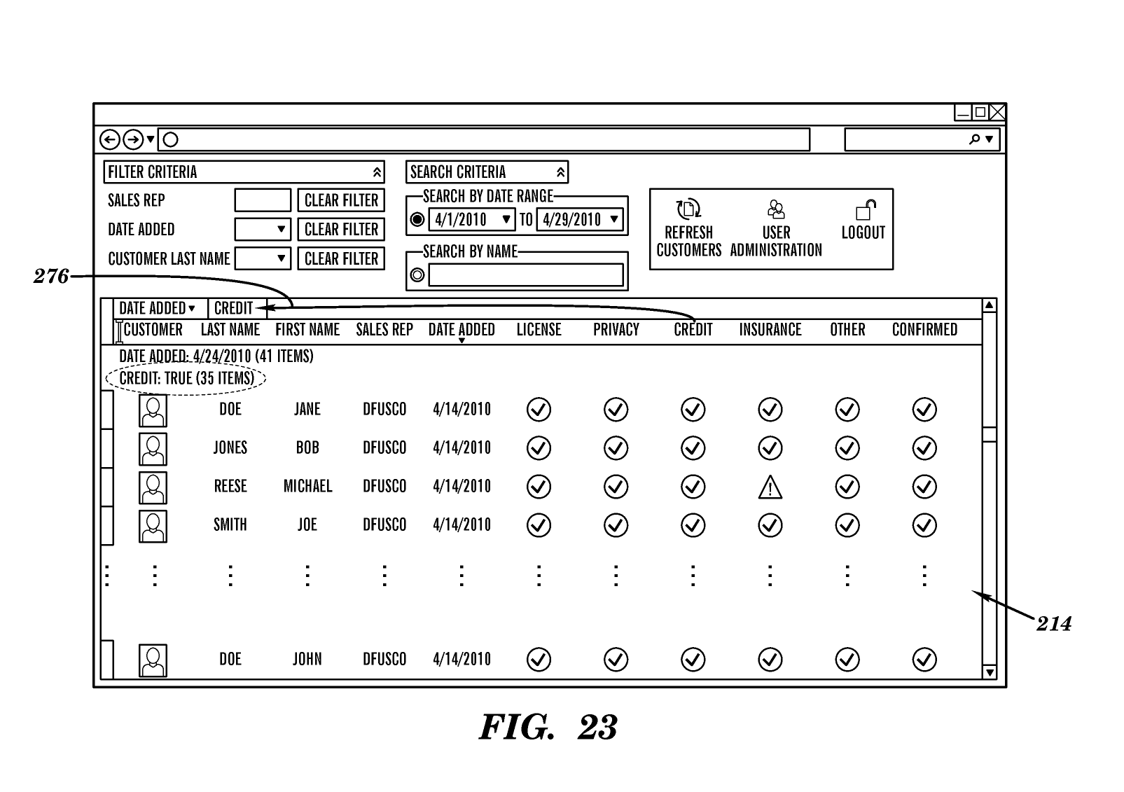

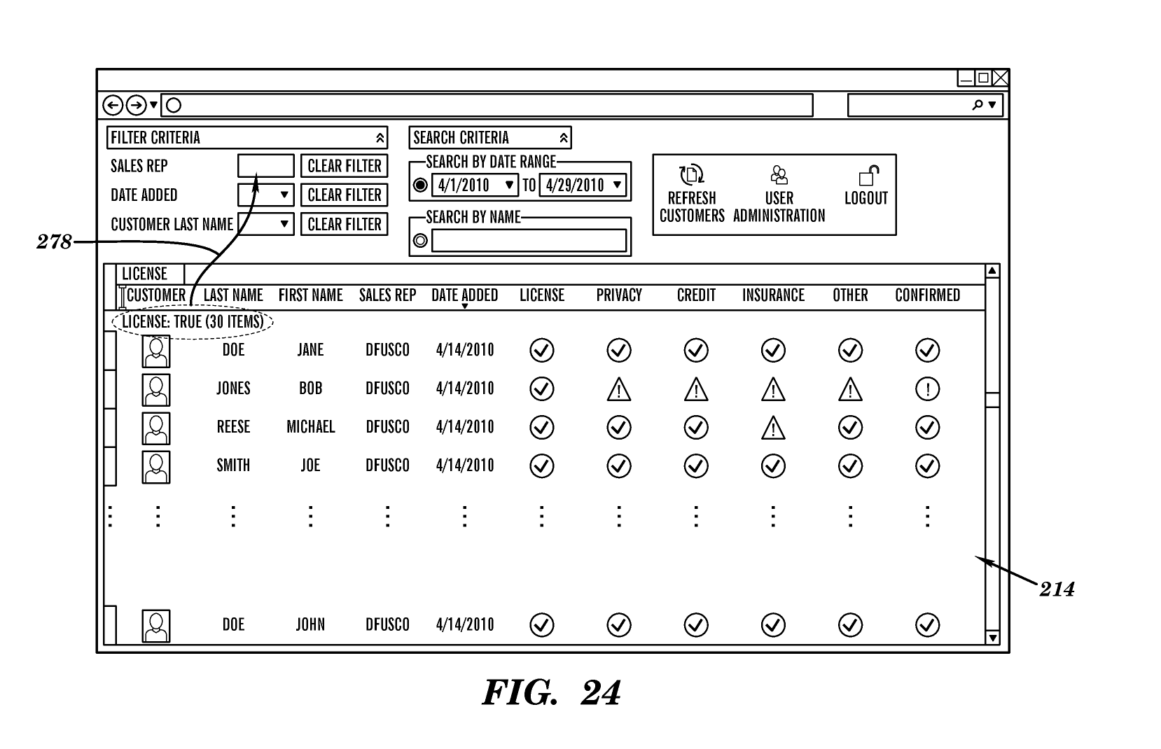

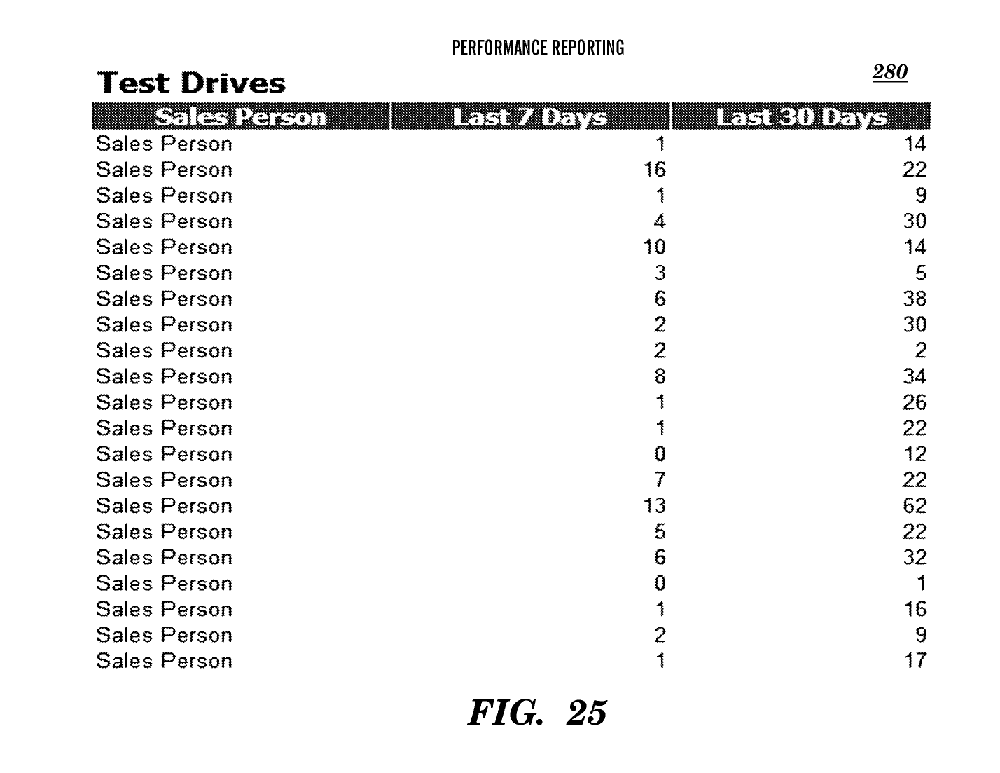

The user may also drag the credit application heading to the top bar to see that the dealership captured credit reports for 35 of those 41 test drives, such as shown at 276 of FIG. 23. As another example, the user may search the monthly data for a particular sales representative, such as shown at 278 of FIG. 24, and/or view summary reports such as the number of test drives provided by each sales representative over predetermined periods (e.g., week, month) etc., as shown in report 280 of FIG. 25.

Embodiments of the present invention thus address the environment that currently creates a liability of potentially $16,000 per piece of paper, and make that process of data collection substantially paper free. (Some funding sources may still require an original signature on the credit application, but this process is now controlled.)

In addition, these embodiments effectively prevent users from running credit without having the appropriate documentation stored in the system. These embodiments thus enforce compliance with designated procedures and/or applicable law.

Moreover, these embodiments provide the dealership with the ability to look at its business from a different perspective than what was available in the past, by virtue of the enforcement technology discussed above.

These capabilities may be provided in a web-based cloud environment, where data may be archived for predetermined time periods (e.g., 7 years).

As discussed above, the embodiments described hereinabove may be provided with various optional features. For example, during conventional motor vehicle sales cycles, once a deal is made on a particular vehicle, a clerk compiles the necessary paperwork for funding, and submits those documents to the lending source. Today, the clerk generally obtains this paperwork from the sales representative, and either puts them into a fax machine or in a FedEx envelope and sends it off to the funding source.

Various embodiments of the present invention may optionally include an electronic drop box feature, such as provided by module 130 (FIG. 6B) in which a user may navigate through the electronic documents associated with the customer, click on those to be selected (and encrypted), and included in a funding packet that for sending to the funding source. The user may then select from a list of funding sources, and hit a submit button to generate an email having a link to a URL containing the funding packet for a particular customer (e.g., Dudley Duke). The individual at the funding entity may then click on the link to access those documents. Those documents may be encrypted, secured and supplied without leaving a trail via email or fax server, or exposing the risk of potentially an incorrect email address, which would expose documents to the wrong party.

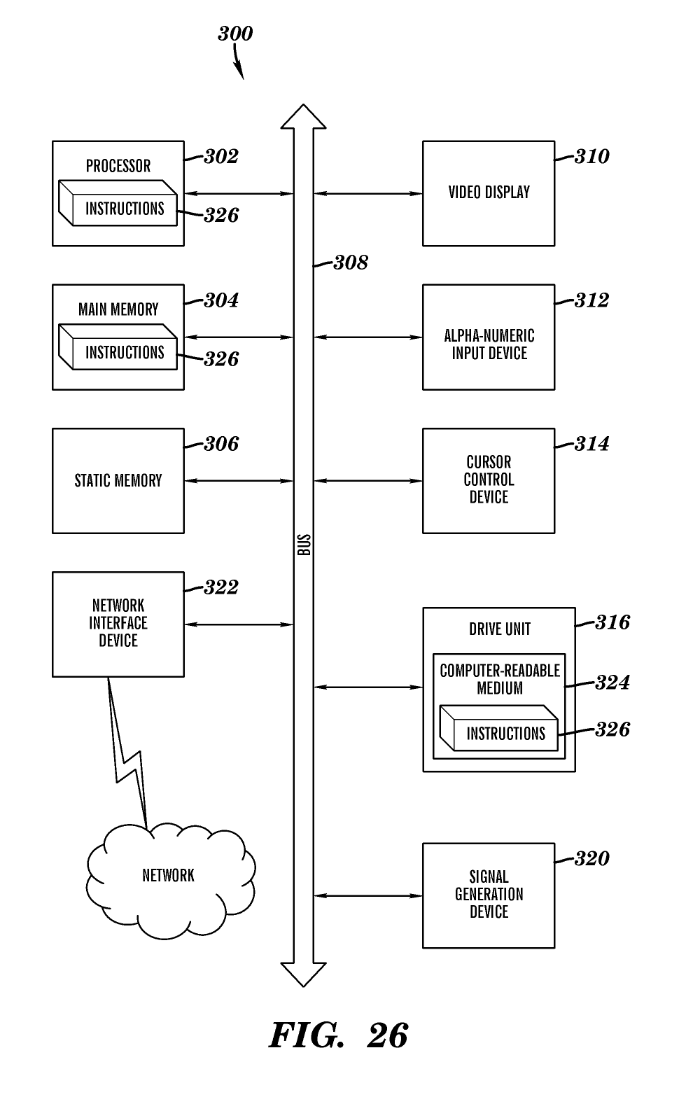

This process would streamline and the funding process and eliminate problems associated with fax machines get jammed, paperwork getting lost, etc., all of which delay the money coming back to the dealership. This skilled artisan will recognize that this drop box functionality may be used with substantially any third party, including credit agencies and the like, such as for auditing purposes. FIG. 26 shows a diagrammatic representation of a machine in the exemplary form of a computer system 300 within which a set of instructions, for causing the machine to perform any one of the methodologies discussed above, may be executed. In alternative embodiments, the machine may include a network router, a network switch, a network bridge, Personal Digital Assistant (PDA), a cellular telephone, a web appliance or any machine capable of executing a sequence of instructions that specify actions to be taken by that machine.

The computer system 300 includes a processor 302, a main memory 304 and a static memory 306, which communicate with each other via a bus 308. The computer system 300 may further include a video display unit 310 (e.g., a liquid crystal display (LCD), plasma, cathode ray tube (CRT), etc.). The computer system 300 may also include an alpha-numeric input device 312 (e.g., a keyboard or touchscreen), a cursor control device 314 (e.g., a mouse), a drive (e.g., disk, flash memory, etc.) unit 316, a signal generation device 320 (e.g., a speaker) and a network interface device 322.

The drive unit 316 includes a computer-readable medium 324 on which is stored a set of instructions (i.e., software) 326 embodying any one, or all, of the methodologies described above. The software 326 is also shown to reside, completely or at least partially, within the main memory 304 and/or within the processor 302. The software 326 may further be transmitted or received via the network interface device 322. For the purposes of this specification, the term “computer-readable medium” shall be taken to include any medium that is capable of storing or encoding a sequence of instructions for execution by the computer and that cause the computer to perform any one of the methodologies of the present invention. The term “computer-readable medium” shall accordingly be taken to include, but not be limited to, solid-state memories, optical and magnetic disks, and carrier wave signals. Thus, a method and apparatus for generating custom reports in a network-based transaction facility have been described. Although the present invention has been described with reference to specific exemplary embodiments, it will be evident that various modifications and changes may be made to these embodiments without departing from the broader spirit and scope of the invention. Accordingly, the specification and drawings are to be regarded in an illustrative rather than a restrictive sense.

Furthermore, embodiments of the present invention include a computer program code-based product, which includes a computer readable storage medium having program code stored therein which can be used to instruct a computer to perform any of the functions, methods and/or modules associated with the present invention. The computer storage medium includes any of, but not limited to, the following: CD-ROM, DVD, magnetic tape, optical disc, hard drive, floppy disk, ferroelectric memory, flash memory, ferromagnetic memory, optical storage, charge coupled devices, magnetic or optical cards, smart cards, EEPROM, EPROM, RAM, ROM, DRAM, SRAM, SDRAM, and/or any other appropriate static or dynamic memory or data storage devices.

It should be noted that the various modules and other components of the embodiments discussed hereinabove may be configured as hardware, as computer readable code stored in any suitable computer usable medium, such as ROM, RAM, flash memory, phase-change memory, magnetic disks, etc., and/or as combinations thereof, without departing from the scope of the present invention.

It should be further understood that any of the features described with respect to one of the embodiments described herein may be similarly applied to any of the other embodiments described herein without departing from the scope of the present invention.

In the preceding specification, the invention has been described with reference to specific exemplary embodiments for the purposes of illustration and description. It is not intended to be exhaustive or to limit the invention to the precise form disclosed. Many modifications and variations are possible in light of this disclosure. It is intended that the scope of the invention be limited not by this detailed description, but rather by the claims appended hereto.

The above systems are implemented in various computing environments. For example, the present invention may be implemented on a conventional IBM PC or equivalent, multi-nodal system (e.g., LAN) or networking system (e.g., Internet, WWW, wireless web). All programming and data related thereto are stored in computer memory, static or dynamic or non-volatile, and may be retrieved by the user in any of: conventional computer storage, display (e.g., CRT, flat panel LCD, plasma, etc.) and/or hardcopy (i.e., printed) formats. The programming of the present invention may be implemented by one skilled in the art of computer systems and/or software design.

Having thus described the invention, what is claimed is:

1. A computer implemented system in a client-server environment, for customer credit information acquisition, aggregation, and maintenance, during a motor vehicle sales cycle, the system comprising:
a server including:
an identification (ID) module configured to capture and associate, in real-time, customer identification data with an electronic customer file;
a credit application module configured to capture and associate, in real-time, a customer credit application with the electronic customer file;
a dashboard module configured to generate an electronic dashboard configured to track and selectively display status of the electronic customer file in real-time;
a verification module configured to capture and associate, in real-time, verification data with the customer file;
an enforcement module configured to selectively permit and prevent acquisition of a credit report for the customer in accordance with the status of the electronic customer file, wherein acquisition is prevented unless said identification (ID) module has captured and associated customer identification data and documentation of said data with an electronic customer file, and unless said credit application module has captured and associated a customer credit application executed by the customer with the electronic customer file;
a credit report module configured to, upon permission by the enforcement module, acquire and associate a credit report for the customer with the electronic customer file;
a time-stamp module configured to apply time-stamps in real-time to the items associated with the electronic customer file;
a data integrity module configured to securely maintain the items associated with the electronic customer file for a predetermined time period subsequent to the time-stamps;
a privacy module configured to capture and associate, in real-time, a privacy statement executed by the customer with the electronic customer file;
an insurance module configured to capture and associate, in real-time, automobile insurance information for the customer with the electronic customer file;
an income module configured to capture and associate, in real-time, proof of income information for the customer with the electronic customer file; and
a residency module configured to capture and associate, in real-time, proof of residency information for the customer with the electronic customer file.

2. A computer implemented system in a client-server environment, for customer credit information acquisition, aggregation, and maintenance, during an automobile sales cycle, the system comprising:
a server including:
an identification (ID) module configured to capture and associate, in real-time, customer identification data with an electronic customer file;
a credit application module configured to capture and associate, in real-time, a customer credit application with the electronic customer file;
a dashboard module configured to generate an electronic dashboard configured to track and selectively display status of the electronic customer file in real-time;
a verification module configured to capture and associate, with a computer, verification data with the customer file;
an enforcement module configured to selectively permit and prevent acquisition of a credit report for the customer in accordance with the status of the electronic customer file,
wherein acquisition is prevented unless said identification (ID) module has captured and associated customer identification data and documentation of said data with an electronic customer file, and unless said credit application module has captured and associated a customer credit application having been executed by the customer with the electronic customer file; and
a credit report module configured to, upon permission by the enforcement module, acquire and associate a credit report for the customer with the electronic customer file;
a time-stamp module configured to apply time-stamps, in real-time, to the items associated with the electronic customer file; and
a data integrity module configured to securely maintain the items associated with the electronic customer file for a predetermined time period subsequent to the time-stamps.

3. (canceled)

4. (canceled)

5. The system of claim 2, further comprising a privacy module configured to capture and associate a privacy statement executed by the customer with the electronic customer file.

6. The system of claim 2, further comprising an insurance module configured to capture and associate automobile insurance information for the customer with the electronic customer file.

7. The system of claim 2, further comprising an income module configured to capture and associate proof of income information for the customer with the electronic customer file.

8. The system of claim 2, further comprising a residency module configured to capture and associate proof of residency information for the customer with the electronic customer file.

9. The system of claim 2, further comprising a permissions module configured to provide selective access to the server by one or more users at one or more client computers.

10. The system of claim 2, wherein the credit application module is configured to permit electronic execution of the credit application by the customer.

11. The system of claim 2, wherein the privacy module is configured to permit electronic execution of the privacy statement by the customer.

12. The system of claim 2, wherein said ID module is configured to capture and associate customer driver's license data with the electronic customer file.

13. The system of claim 2, wherein the server is configured to maintain electronic customer files for a plurality of customers.

14. The system of claim 13, wherein the server is configured to associate each of said plurality of customer files with a user.

15. The system of claim 14, wherein the server is configured to associate each of said plurality of customer files with a sales representative associated with the user.

16. The system of claim 15, further comprising a permissions module configured to provide selective access to the server by one or more users at one or more client computers.

17. The system of claim 16, wherein the permissions module is configured to provide user access to customers associated with that user.

18. The system of claim 14, further comprising a report module configured to generate a report displaying status of electronic customer files for any one said plurality of customers.

19. The system of claim 2, further comprising a drop-box module configured to encrypt and associate any of the items associated with the electronic customer file with a URL for selective access by a motor vehicle financing entity.

20. The system of claim 2, further comprising a test drive module configured to capture and associate with the electronic customer file, information pertaining to whether the customer test drove a motor vehicle.

21. The system of claim 20, wherein the test drive module is configured to capture and associate with the electronic customer file, information pertaining to whether the customer purchased a motor vehicle.

22. A computer implemented method in a client-server environment, for customer credit information acquisition, aggregation, and maintenance, in real-time during a motor vehicle sales cycle, the method comprising:
at the server:
(a) capturing and associating, with a computer, customer identification data with an electronic customer file;
(b) capturing and associating, with a computer in real-time, a customer credit application with the electronic customer file;
(c) generating and configuring, with a computer in real-time, an electronic dashboard to track and selectively display status of the electronic customer file;
(d) capturing and associating, with a computer in real-time, verification data with the customer file;
(e) selectively permitting and preventing acquisition, with a computer in real-time, of a credit report for the customer in accordance with the status of the electronic customer file;
(f) upon permission by the enforcement module, acquiring and associating a credit report, with a computer in real-time, for the customer with the electronic customer file;
(g) applying time-stamps, with a computer in real time, to the items associated with the electronic customer file;
(h) maintaining the items, with a computer, for a predetermined time period subsequent to the time-stamps;
(i) capturing and associating, with a computer in real-time, a privacy statement executed by the customer with the electronic customer file;
(j) capturing and associating, with a computer in real-time, automobile insurance information for the customer with the electronic customer file;
(k) capturing and associating, with a computer in real time, proof of income information for the customer with the electronic customer file; and
(l) capturing and associating, with a computer in real-time, proof of residency information for the customer with the electronic customer file;

23. A computer implemented method in a client-server environment, for customer credit information acquisition, aggregation, and maintenance, during a motor vehicle sales cycle, the method comprising:
at the server:
(a) capturing and associating, with a computer in real-time, customer identification data with an electronic customer file;
(b) capturing and associating, with a computer in real-time, a customer credit application with the electronic customer file;
(c) generating and configuring, with a computer in real-time, an electronic dashboard to track and selectively display status of the electronic customer file;
(d) capturing and associating, with a computer, verification data with the customer file;
(e) selectively permitting and preventing acquisition of a credit report for the customer in accordance with the status of the electronic customer file; and
(f) upon permission by the enforcement module, acquiring and associating a credit report, with a computer, for the customer with the electronic customer file;

24. The method of claim 23, further comprising applying time-stamps to the items associated with the electronic customer file.

25. The method of claim 24, further comprising maintaining the items for a predetermined time period subsequent to the time-stamps.

26. The method of claim 23, further comprising capturing and associating a privacy statement executed by the customer with the electronic customer file.

27. The method of claim 23, further comprising capturing and associating automobile insurance information for the customer with the electronic customer file.

28. The method of claim 23, further comprising capturing and associating proof of income information for the customer with the electronic customer file.

29. The method of claim 23, further comprising capturing and associating proof of residency information for the customer with the electronic customer file.

30. The method of claim 23, further comprising providing selective access to the server by one or more users at one or more client computers.

31. The method of claim 23, further comprising permitting electronic execution of the credit application by the customer.

32. The method of claim 23, further comprising permitting electronic execution of the privacy statement by the customer.

33. The method of claim 23, wherein said capturing and associating (a) further comprises capturing and associating customer driver's license data with the electronic customer file.

34. The method of claim 23, further comprising maintaining electronic customer files for a plurality of customers.

35. The method of claim 34, further comprising associating each of said plurality of customer files with a user.

36. The method of claim 35, further comprising associating each of said plurality of customer files with a sales representative associated with the user.

37. The method of claim 36, further comprising providing selective access to the server by one or more users at one or more client computers.

38. The method of claim 37, further comprising providing user access to customers associated with that user.

39. The method of claim 35, further comprising generating a report displaying status of electronic customer files for any one said plurality of customers.

40. The method of claim 23, further comprising encrypting and associating any of the items associated with the electronic customer file with a URL for selective access by a motor vehicle financing entity.

41. The method of claim 23, further comprising capturing and associating with the electronic customer file, information pertaining to whether the customer test drove a motor vehicle.

42. The method of claim 41, further comprising capturing and associating with the electronic customer file, information pertaining to whether the customer purchased a motor vehicle.

43. An article of manufacture for computer for customer credit information acquisition, aggregation, and maintenance, in a client-server environment during a motor vehicle sales cycle, said article of manufacture comprising:
a non-transitory computer usable medium having a computer readable program code embodied therein, said computer usable medium having computer readable program code for:
(a) capturing and associating, in real-time, customer identification data with an electronic customer file;
(b) capturing and associating, in real-time, a customer credit application with the electronic customer file;
(c) generating and configuring, in real-time, an electronic dashboard to track and selectively display status of the electronic customer file;
(d) capturing and associating verification data with the customer file;
(e) selectively permitting and preventing acquisition of a credit report for the customer in accordance with the status of the electronic customer file; and
(f) upon permission by the enforcement module, acquiring and associating a credit report for the customer with the electronic customer file.

44. The system of claim 2, where said verification data includes one or more of OFAC reports, Red Flag reports, payroll checks, proof of employment, proof of residency, utility bills, references, loan balances, used car appraisals, payoff verification, VIN verification, a signed credit application, and a customer's signature on a privacy statement.
